(19) United States
(12) Patent Application Publication
(10) Pub. No.: US 2024/0070752 A1
(43) Pub. Date: Feb. 29, 2024

(54) INFORMATION PROCESSING METHOD, INFORMATION PROCESSING APPARATUS, AND PROGRAM

(71) Applicant: FUJIFILM Corporation, Tokyo (JP)

(72) Inventors: Masahiro SATO, Tokyo (JP); Tomoki TANIGUCHI, Tokyo (JP); Tomoko OHKUMA, Tokyo (JP)

(73) Assignee: FUJIFILM Corporation, Tokyo (JP)

(21) Appl. No.: 18/457,358

(22) Filed: Aug. 29, 2023

(30) Foreign Application Priority Data
Aug. 31, 2022 (JP) 2022-138787

(51) Int. Cl. G06Q 30/0601

(52) U.S. Cl. CPC G06Q 30/0631

(57) ABSTRACT

There is provided an information processing method, an information processing apparatus, and a program capable of preparing a high performance model for an unknown introduction destination facility even in a case where a domain of the introduction destination facility is unknown at a step of training a model. The information processing method includes: dividing a dataset, which indicates a behavior of a user on an item for each of combinations of a plurality of the users and a plurality of the items, into a plurality of subgroups that are robust with respect to domain shift; generating a local model for performing a prediction of the behavior of the user on the item for each of the subgroups; and combining a plurality of the local models generated for each of the subgroups.

### CROSS-REFERENCE TO RELATED APPLICATION

The present application claims priority under 35 U.S.C § 119(a) to Japanese Patent Application No. 2022-138787 filed on Aug. 31, 2022, which is hereby expressly incorporated by reference, in its entirety, into the present application.

### BACKGROUND OF THE INVENTION

### 1. Field of the Invention

The present invention relates to an information processing method, an information processing apparatus, and a program, and more particularly to an information suggestion technique for making a robust suggestion for a domain shift.

### 2. Description of the Related Art

It is difficult for a user to select the best item that suits him/herself from many items in terms of time and cognitive ability. For example, in the case of a user of the electronic commerce (EC) site, the item is a product handled by the EC site, and in the case of a user of a document information management system, the item is the stored document information. In order to assist the user's selection, an information suggestion technique, which is a technique of presenting a selection candidate from items, has been studied.

Generally, a suggestion system performs a training based on data collected at an introduction destination facility. However, in a case where the suggestion system is introduced in a facility different from learning data, there is a problem that the prediction accuracy of the model is decreased. The problem that a machine learning model does not work well at unknown other facilities is called domain shift, and research related to domain generalization, which is research on improving robustness with respect to the domain shift, has been active in recent years, mainly in the field of image recognition. However, in the information suggestion technique, there is no research case for domain generalization yet.

Even in a case where the data of the introduction destination facility cannot be obtained at the time of a model learning, in a case where the data that is collected at the introduction destination facility is present at the time of the introduction, the data can be used to evaluate models and the best model can be selected. However, it is not possible to select from a plurality of models in a case where the data of the introduction destination facility is not present even at the time of the introduction, or in a case where access is not possible even in a case where the data is present.

Badrul Sarwar, George Karypis, Joseph Konstan, and John Riedl, “Recommender Systems for Large-Scale E-Commerce Scalable Neighborhood Formation Using Clustering” (2002 ICCIT) discloses a technique of reducing a calculation cost at the time of recommendation by dividing users into a plurality of subgroups and performing prediction by using a collaborative filtering (a partial model) for each subgroup.

Bin Xu, Jiajun Bu, Chun Chen, Deng Cai, “An exploration of improving collaborative recommender systems via user-item subgroups” (2012 WWW) discloses a technique of dividing pairs of users and items into a plurality of subgroups, performing prediction by using a collaborative filtering (a partial model) for each subgroup, and thereby reducing a calculation cost and improving prediction accuracy.

However, since neither Badrul Sarwar, George Karypis, Joseph Konstan, and John Riedl, “Recommender Systems for Large-Scale E-Commerce Scalable Neighborhood Formation Using Clustering” (2002 ICCIT) nor Bin Xu, Jiajun Bu, Chun Chen, Deng Cai, “An exploration of improving collaborative recommender systems via user-item subgroups” (2012 WWW) is a method aiming at domain generalization, subgroups are built without considering the domain generalization, and each partial model is not robust against domain shift.

JP2019-526851A discloses a technique that assumes medical information, which is a technique of generating pseudo data (proxy data) at each facility and sharing the data with a global server. According to this technique, it is possible to train a global model without sharing real data (private data) having high confidentiality.

JP2021-121922A discloses a technique that assumes a suggestion system, which is a technique in which a feature is selected by using data of a plurality of facilities. This technique uses a feature importance of a tree model (such as XGBoost) based on user sample data common to facilities.

### SUMMARY OF THE INVENTION

However, in the techniques disclosed in JP2019-526851A and JP2021-121922A, the model of each facility does not have the domain generalization, and robustness to other unknown facilities cannot be ensured. As described above, in a case where the learning domain and the introduction destination domain are different from each other, there is a problem that robust information cannot be suggested for the domain shift.

The present invention has been made in view of such circumstances, and it is an object of the present invention to provide an information processing method, an information processing apparatus, and a program capable of preparing a high performance model for an unknown introduction destination facility even in a case where a domain of the introduction destination facility is unknown at a step of training a model.

In order to achieve the above object, an information processing method according to a first aspect of the present disclosure is an information processing method executed by one or more processors, the information processing method comprises: causing the one or more processors to execute: dividing a dataset, which indicates a behavior of a user on an item for each of combinations of a plurality of the users and a plurality of the items, into a plurality of subgroups that are robust with respect to domain shift; generating a local model for performing a prediction of the behavior of the user on the item for each of the subgroups; and combining a plurality of the local models generated for each of the subgroups.

According to the present aspect, since local models of subgroups that are robust with respect to the domain shift are generated, by combining the plurality of local models, it is possible to prepare a high-performance model for an unknown introduction destination facility even in a case where the domain of the introduction destination facility is unknown at the step of training the model.

In the information processing method according to the first aspect, in a case where the local model, which is generated based on the subgroup, is robust with respect to the domain shift, the subgroup is robust with respect to the domain shift. In the information processing method according to the first aspect, dividing the dataset into the plurality of subgroups, which are robust with respect to the domain shift, is not limited to a case where the subgroups are intended to be robust with respect to the domain shift in a case of dividing the dataset into the subgroups, and includes a case where the divided subgroups are robust with respect to the domain shift as a result.

In the information processing method according to the first aspect, the dataset may be generated based on the data of the behavior of the user on the item collected at a single facility. Further, in the information processing method according to the first aspect, the one or more processors may divide the dataset based on at least one of the attribute data of the user or the attribute data of the item.

The information processing method of the present disclosure can be understood as a machine learning method for generating a model applied to a system that performs an information suggestion. Further, the information processing method of the present disclosure can be understood as a method (manufacturing method) for producing a model.

In the information processing method of a second aspect of the present disclosure according to the information processing method of the first aspect, the dataset may indicate the behavior of the user on the item for each of combinations of the plurality of users, the plurality of items, and a plurality of contexts.

In the information processing method of a third aspect of the present disclosure according to the information processing method of the first to second aspects, the one or more processors may divide the dataset based on at least one of attribute data of the user, attribute data of the item, or attribute data of the context. For example, the one or more processors may divide the dataset into the subgroups consisting of users having the same user attribute data. The one or more processors may divide the dataset into subgroups consisting of users having the same user attribute data and consisting of items having the same item attribute data. The one or more processors may divide the dataset into subgroups consisting of users having the same user attribute data, consisting of items having the same item attribute data, and consisting of contexts having the same context attribute data. The present disclosure is not limited to the case where the dataset is divided based on the same attribute data, and the dataset may be divided based on the same or similar attribute data.

The information processing method of a fourth aspect of the present disclosure according to the information processing method of any one of the first to fourth aspects may include causing the one or more processors to execute: performing an evaluation of robustness of a model, in which the plurality of local models are combined, with respect to the domain shift; and adopting division of the subgroup in a case where a result of the evaluation satisfies a standard. In a case where the result of the evaluation of the robustness of the model with respect to the domain shift satisfies the standard, the plurality of divided subgroups are robust with respect to the domain shift.

The information processing method of a fifth aspect of the present disclosure according to the information processing method of the fourth aspect may include causing the one or more processors to execute dividing the dataset into the plurality of subgroups by using attribute data having a relatively large difference in probability distribution between a domain of the dataset and a domain of the dataset that is used for the evaluation. By dividing the dataset into the plurality of subgroups by using the attribute data with relatively large differences in the probability distributions, the dataset can be divided into the plurality of subgroups that are robust with respect to the domain shift.

The information processing method of a sixth aspect of the present disclosure according to the information processing method of any one of the first to fifth aspects may include causing the one or more processors to execute dividing the dataset into the plurality of subgroups in which each user belongs to at least one or more of the subgroups.

The information processing method of a seventh aspect of the present disclosure according to the information processing method of any one of the first to sixth aspects may include causing the one or more processors to execute dividing the dataset into the plurality of subgroups in which at least a certain number or more of the items belong to each user. The certain number or more of the items may include a concept of a certain ratio or more of items with respect to all items.

The information processing method of an eighth aspect of the present disclosure according to the information processing method of any one of the first to seventh aspects may include causing the one or more processors to execute generating different types of local models for each of the subgroups.

The information processing method of a ninth aspect of the present disclosure according to the information processing method of any one of the first to eighth aspects may include causing the one or more processors to execute: generating a pre-trained model based on a wider range of data than the subgroup in the dataset; and generating the local model using the pre-trained model as an initial parameter.

The information processing method of a tenth aspect of the present disclosure according to the information processing method of any one of the first to ninth aspects may include causing the one or more processors to execute outputting an item list, which is suggested to the user, by using a model in which the plurality of local models are combined.

In order to achieve the above object, an information processing apparatus according to an eleventh aspect of the present disclosure is an information processing apparatus that comprises: one or more processors; and one or more memories in which instructions to be executed by the one or more processors are stored, in which the one or more processors are configured to: divide a dataset, which indicates a behavior of a user on an item for each of combinations of a plurality of the users and a plurality of the items, into a plurality of subgroups that are robust with respect to domain shift; generate a local model for performing a prediction of the behavior of the user on the item for each of the subgroups; and combine a plurality of the local models generated for each of the subgroups.

The information processing apparatus according to the eleventh aspect may include the same specific aspects as the above-described information processing method.

In order to achieve the above object, a program according to a twelfth aspect of the present disclosure is a program that causes a computer to realize: a function of dividing a dataset, which indicates a behavior of a user on an item for each of combinations of a plurality of the users and a plurality of the items, into a plurality of subgroups that are robust with respect to domain shift; a function of generating a local model for performing a prediction of the behavior of the user on the item for each of the subgroups; and a function of combining a plurality of the local models generated for each of the subgroups.

In the program of the twelfth aspect, the configuration can include the same specific aspects as the above-described information processing method.

In order to achieve the above object, an information processing method according to another aspect of the present disclosure is an information processing method executed by one or more processors, the information processing method comprises: causing the one or more processors to execute: dividing a dataset, which indicates a behavior of a user on an item for each of combinations of a plurality of the users and a plurality of the items, into a plurality of subgroups; generating a local model for performing a prediction of the behavior of the user on the item for each of the subgroups; combining a plurality of the local models generated for each of the subgroups; evaluating the robustness of the plurality of local models with respect to the domain shift; and adopting the division of the subgroups in a case where the result of the evaluation satisfies the standard.

According to the present aspect, since local models of subgroups that are robust with respect to the domain shift are generated, by combining the plurality of local models, it is possible to prepare a high-performance model for an unknown introduction destination facility even in a case where the domain of the introduction destination facility is unknown at the step of training the model.

According to the present disclosure, even in a case where the domain of the introduction destination facility is unknown at the step of training the model, it is possible to generate a plurality of models capable of corresponding to various facilities, and a high performance model can be prepared for the unknown introduction destination facility.

### BRIEF DESCRIPTION OF THE DRAWINGS

FIG. 1 is a conceptual diagram of a typical suggestion system.

FIG. 2 is a conceptual diagram showing an example of supervised machine learning that is widely used in building a suggestion system.

FIG. 3 is an explanatory diagram showing a typical introduction flow of the suggestion system.

FIG. 4 is an explanatory diagram of an introduction flow of the suggestion system in a case where data of an introduction destination facility cannot be obtained.

FIG. 5 is an explanatory diagram in a case where a model is trained by domain adaptation.

FIG. 6 is an explanatory diagram of an introduction flow of the suggestion system including a step of evaluating the performance of the trained model.

FIG. 7 is an explanatory diagram showing an example of training data and evaluation data used for the machine learning.

FIG. 8 is a graph schematically showing a difference in performance of a model due to a difference in a dataset.

FIG. 9 is an explanatory diagram showing an example of an introduction flow of the suggestion system in a case where a learning domain and an introduction destination domain are different from each other.

FIG. 10 is an explanatory diagram showing a problem in a case where data of the introduction destination facility is not present.

FIG. 11 is a diagram showing a dataset.

FIG. 12 is a diagram illustrating a local model in federated learning.

FIG. 13 is a diagram illustrating a local model in federated learning.

FIG. 14 is a diagram of a dataset illustrating a local model in the present disclosure.

FIG. 15 is a diagram of a dataset illustrating a local model in the present disclosure.

FIG. 16 is a block diagram schematically showing an example of a hardware configuration of an information processing apparatus.

FIG. 17 is a functional block diagram showing a functional configuration of the information processing apparatus.

FIG. 18 is a chart showing an example of behavior history data.

FIG. 19 is a diagram illustrating division of subgroups.

FIG. 20 is an explanatory diagram showing an information suggestion flow according to Embodiment 1.

FIG. 21 is a diagram illustrating a dataset of a combination of a user, an item, and a context.

FIG. 22 is an explanatory diagram showing a subgroup division flow according to Embodiment 3.

FIG. 23 is an explanatory diagram showing a subgroup division flow according to Embodiment 3.

FIG. 24 is a diagram showing an example of subgroup division.

FIG. 25 is an explanatory diagram showing a subgroup division flow according to Embodiment 4.

FIG. 26 is a diagram illustrating an attribute for the subgroup division.

FIG. 27 is a diagram illustrating a local model for each subgroup.

FIG. 28 is an explanatory diagram showing a learning flow according to Embodiment 7.

### DESCRIPTION OF THE PREFERRED EMBODIMENTS

Hereinafter, preferred embodiments of the present invention will be described with reference to the accompanying drawings.

Overview of Information Suggestion Technique

First, the outline and problems of an information suggestion technique will be overviewed by showing specific examples. The information suggestion technique is a technique for suggesting an item to a user.

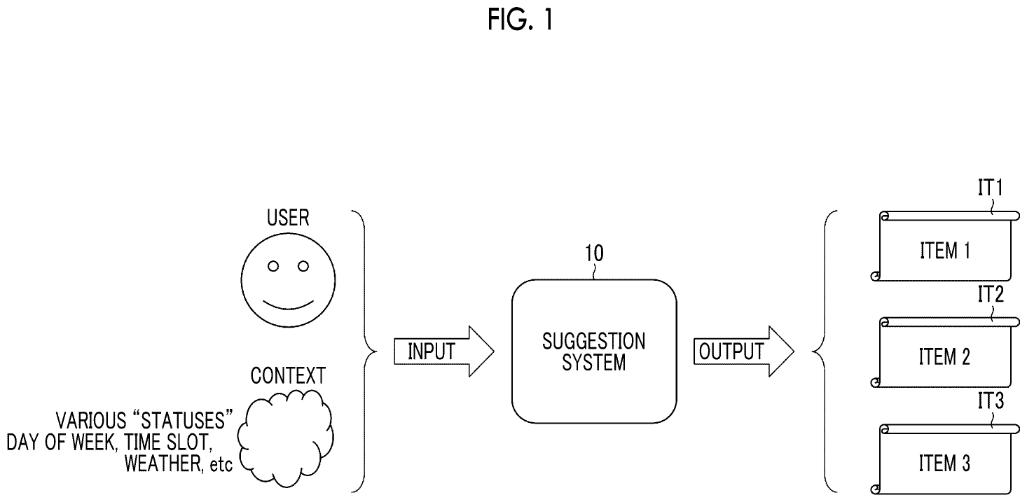

FIG. 1 is a conceptual diagram of a typical suggestion system 10. The suggestion system 10 receives user information and context information as inputs and outputs information of the item that is suggested to the user according to a context. The context means various “statuses” and may be, for example, a day of the week, a time slot, or the weather. The items may be various objects such as a book, a video, a restaurant, and the like.

The suggestion system 10 generally suggests a plurality of items at the same time. FIG. 1 shows an example in which the suggestion system 10 suggests three items of IT1, IT2, and IT3. In a case where the user responds positively to the suggested items IT1, IT2, and IT3, the suggestion is generally considered to be successful. A positive response is, for example, a purchase, browsing, or visit. Such a suggestion technique is widely used, for example, in an EC site, a gourmet site that introduces a restaurant, and the like.

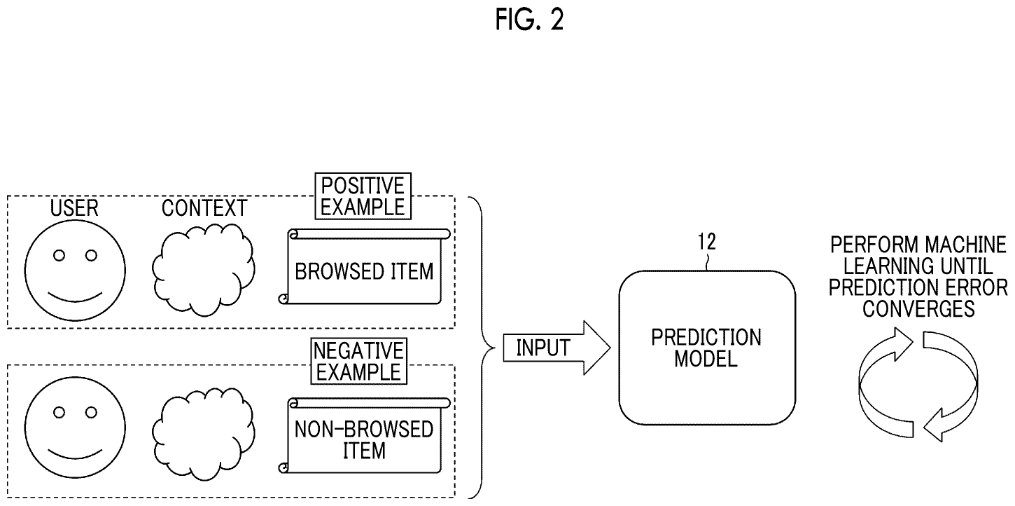

The suggestion system 10 is built by using a machine learning technique. FIG. 2 is a conceptual diagram showing an example of supervised machine learning that is widely used in building the suggestion system 10. Generally, a positive example and a negative example are prepared based on a user behavior history in the past, a combination of the user and the context is input to a prediction model 12, and the prediction model 12 is trained such that a prediction error becomes small. For example, a browsed item that is browsed by the user is defined as a positive example, and a non-browsed item that is not browsed by the user is defined as a negative example. The machine learning is performed until the prediction error converges, and the target prediction performance is acquired.

By using the trained prediction model 12, which is trained in this way, items with a high browsing probability, which is predicted with respect to the combination of the user and the context, are suggested. For example, in a case where a combination of a certain user A and a context β is input to the trained prediction model 12, the prediction model 12 infers that the user A has a high probability of browsing a document such as the item IT3 under a condition of the context β and suggests an item similar to the item IT3 to the user A. Depending on the configuration of the suggestion system 10, items are often suggested to the user without considering the context.

Example of Data Used for Developing Suggestion System

The user behavior history is substantially equivalent to “correct answer data” in machine learning. Strictly speaking, it is understood as a task setting of inferring the next (unknown) behavior from the past behavior history, but it is general to train the latent feature based on the past behavior history.

The user behavior history may include, for example, a book purchase history, a video browsing history, or a restaurant visit history.

Further, main features include a user attribute and an item attribute. The user attribute may have various elements such as, for example, gender, age group, occupation, family structure, and residential area. The item attribute may have various elements such as a genre and a price of a book, a genre and a length of a video, and a genre and a place of a restaurant.

Model Building and Operation

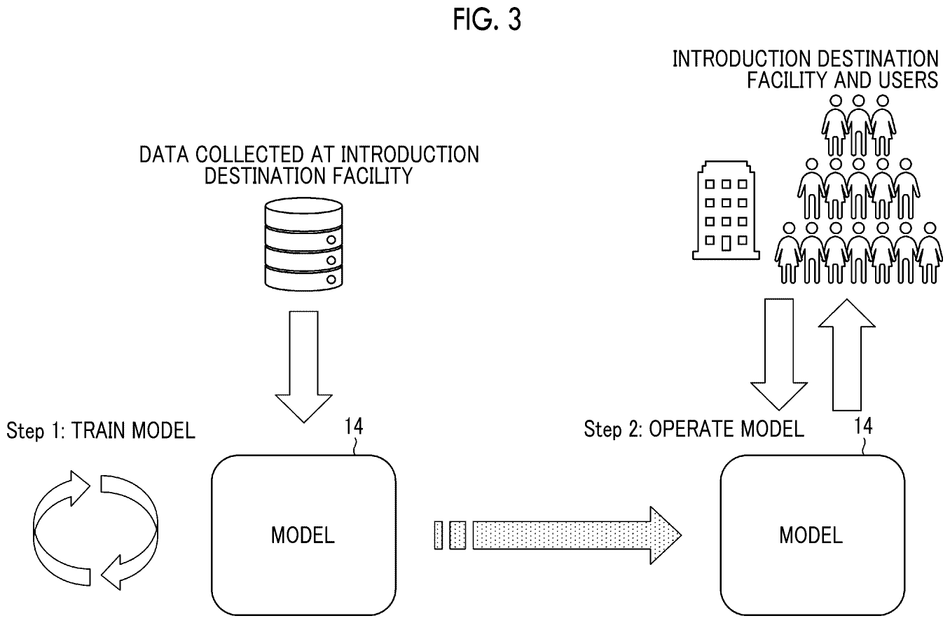

FIG. 3 is an explanatory diagram showing a typical introduction flow of the suggestion system. Here, a typical flow in a case where the suggestion system is introduced to a certain facility, is shown. To introduce the suggestion system, first, a model 14 for performing a target suggestion task is built (Step 1), and then the built model 14 is introduced and operated (Step 2). In the case of a machine learning model, “Building” the model 14 includes training the model 14 by using training data to create a prediction model (suggestion model) that satisfies a practical level of suggestion performance. “Operating” the model 14 is, for example, obtaining an output of a suggested item list from the trained model 14 with respect to the input of the combination of the user and the context.

Data for a training is required for building the model 14. As shown in FIG. 3, in general, the model 14 of the suggestion system is trained based on the data collected at an introduction destination facility. By performing training by using the data collected from the introduction destination facility, the model 14 learns the behavior of the user in the introduction destination facility and can accurately predict suggested items for the user in the introduction destination facility.

However, due to various circumstances, it may not be possible to obtain data on the introduction destination facility. For example, in the case of a document information suggestion system in an in-house system of a company or an in-hospital system of a hospital, a company that develops a suggestion model often cannot access the data of the introduction destination facility. In a case where the data of the introduction destination facility cannot be obtained, instead, it is necessary to perform training based on data collected at different facilities.

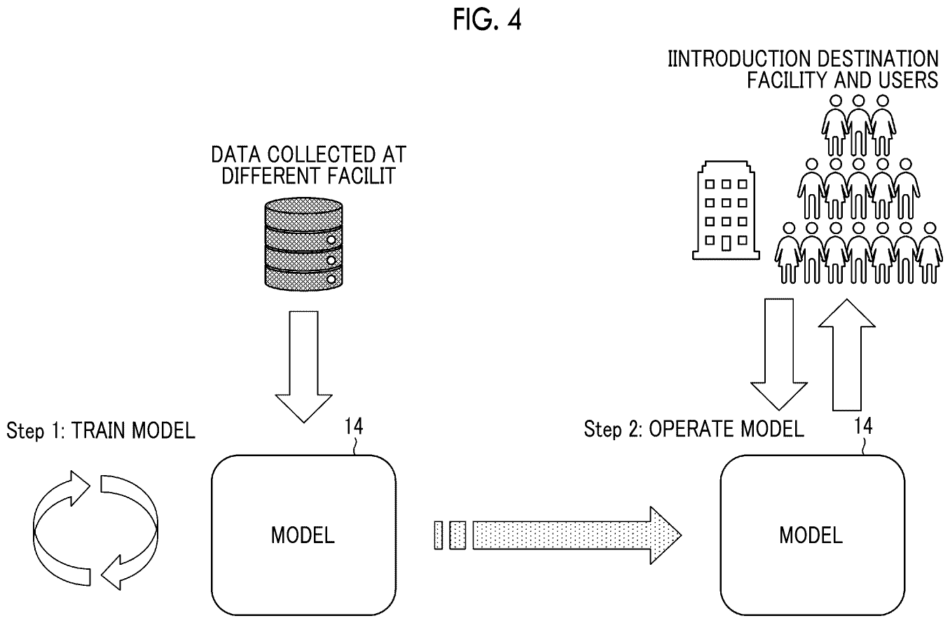

FIG. 4 is an explanatory diagram of an introduction flow of the suggestion system in a case where data of an introduction destination facility cannot be obtained. In a case where the model 14, which is trained by using the data collected in a facility different from the introduction destination facility, is operated in the introduction destination facility, there is a problem that the prediction accuracy of the model 14 decreases due to differences in user behavior between facilities.

The problem that the machine learning model does not work well in unknown facilities different from the trained facility is understood as a technical problem, in a broad sense, to improve robustness with respect to a problem of domain shift in which a source domain where the model 14 is trained differs from a target domain where the model 14 is applied. Domain adaptation is a problem setting related to domain generalization. This is a method of training by using data from both the source domain and the target domain. The purpose of using the data of different domains in spite of the presence of the data of the target domain is to make up for the fact that the amount of data of the target domain is small and insufficient for a training.

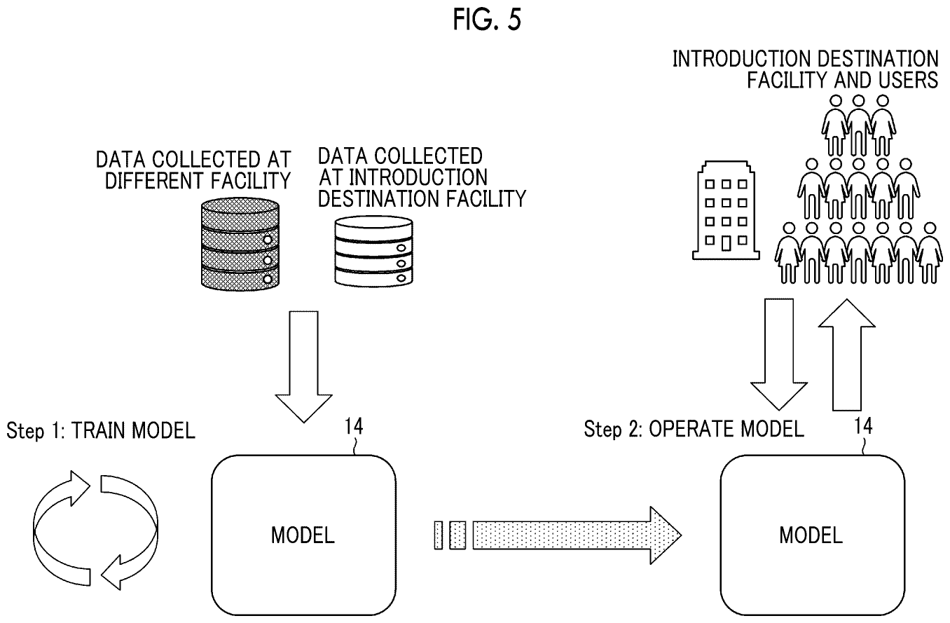

FIG. 5 is an explanatory diagram in a case where the model 14 is trained by domain adaptation. Although the amount of data collected at the introduction destination facility that is the target domain is relatively smaller than the amount of data collected at a different facility, the model 14 can also predict with a certain degree of accuracy the behavior of the users in the introduction destination facility by performing a training by using both data.

Description of Domain

The above-mentioned difference in a “facility” is a kind of difference in a domain. In Ivan Cantador, Ignacio Fenandez-Tobias, Shlomo Bwrkovsky, Paolo Cremonesi, Chapter 27: “Cross-domain Recommender System” (2015 Springer), which is a document related to research on domain adaptation in information suggestion, differences in domains are classified into the following four categories.
[1] Item attribute level: For example, a comedy movie and a honor movie are in different domains.
[2] Item type level: For example, a movie and a TV drama series are in different domains.
[3] Item level: For example, a movie and a book are in different domains.
[4] System level: For example, a movie in a movie theater and a movie broadcast on television are in different domains.

The difference in “facility” shown in FIG. 5 or the like corresponds to [4] system-level domain in the above four categories.

In a case where a domain is formally defined, the domain is defined by a simultaneous probability distribution P(X, Y) of a response variable Y and an explanatory variable X, and in a case where Pd1 (X, Y)≠Pd2(X, Y), d1 and d2 are different domains.

The simultaneous probability distribution P(X, Y) can be represented by a product of an explanatory variable distribution P(X) and a conditional probability distribution P(Y|X) or a product of a response variable distribution P(Y) and a conditional probability distribution P(Y|X).

P(X,Y)=P(Y|X)P(X)=P(X|Y)P(Y)

Therefore, in a case where one or more of P(X), P(Y), P(Y|X), and P(X|Y) is changed, the domains become different from each other.

Typical Pattern of Domain Shift

Covariate Shift

A case where distributions P(X) of explanatory variables are different is called a covariate shift. For example, a case where distributions of user attributes are different between datasets, more specifically, a case where a gender ratio is different, and the like correspond to the covariate shift.

Prior Probability Shift

A case where distributions P(Y) of the response variables are different is called a prior probability shift. For example, a case where an average browsing rate and an average purchase ratio differs between datasets corresponds to the prior probability shift.

Concept Shift

A case where conditional probability distributions P(Y|X) and P(X|Y) are different is called a concept shift. For example, a probability that a research and development department of a certain company reads data analysis materials is assumed as P(YIX), and in a case where the probability differs between datasets, this case corresponds to the concept shift.

Research on domain adaptation or domain generalization includes assuming one of the above-mentioned patterns as a main factor and looking at dealing with P(X, Y) changing without specifically considering which pattern is a main factor. In the former case, there are many cases in which a covariate shift is assumed.

Reason for Influence of Domain Shift

A prediction/classification model that performs a prediction or classification task makes inferences based on a relationship between the explanatory variable X and the response variable Y, thereby in a case where P(YIX) is changed, naturally the prediction/classification performance is decreased. Further, although minimization of a prediction/classification error is performed within learning data in a case where machine learning is performed on the prediction/classification model, for example, in a case where the frequency in which the explanatory variable becomes X=X_1 is greater than the frequency in which the explanatory variable becomes X=X_2, that is, in a case where P(X=X_1)>P(X=X_2), the data of X=X_1 is more than the data of X=X_2, thereby error decrease for X=X_1 is trained in preference to error decrease for X=X_2. Therefore, even in a case where P(X) is changed between the facilities, the prediction/classification performance is decreased.

The domain shift can be a problem not only for information suggestion but also for various task models. For example, regarding a model that predicts the retirement risk of an employee, a domain shift may become a problem in a case where a prediction model, which is trained by using data of a certain company, is operated by another company.

Further, in a model that predicts an antibody production amount of a cell, a domain shift may become a problem in a case where a model, which is trained by using data of a certain antibody, is used for another antibody. Further, for a model that classifies the voice of customer (VOC), for example, a model that classifies VOC into “product function”, “support handling”, and “other”, a domain shift may be a problem in a case where a classification model, which is trained by using data related to a certain product, is used for another product.

Regarding Evaluation before Introduction of Model

In many cases, a performance evaluation is performed on the model 14 before the trained model 14 is introduced into an actual facility or the like. The performance evaluation is necessary for determining whether or not to introduce the model and for research and development of models and learning methods.

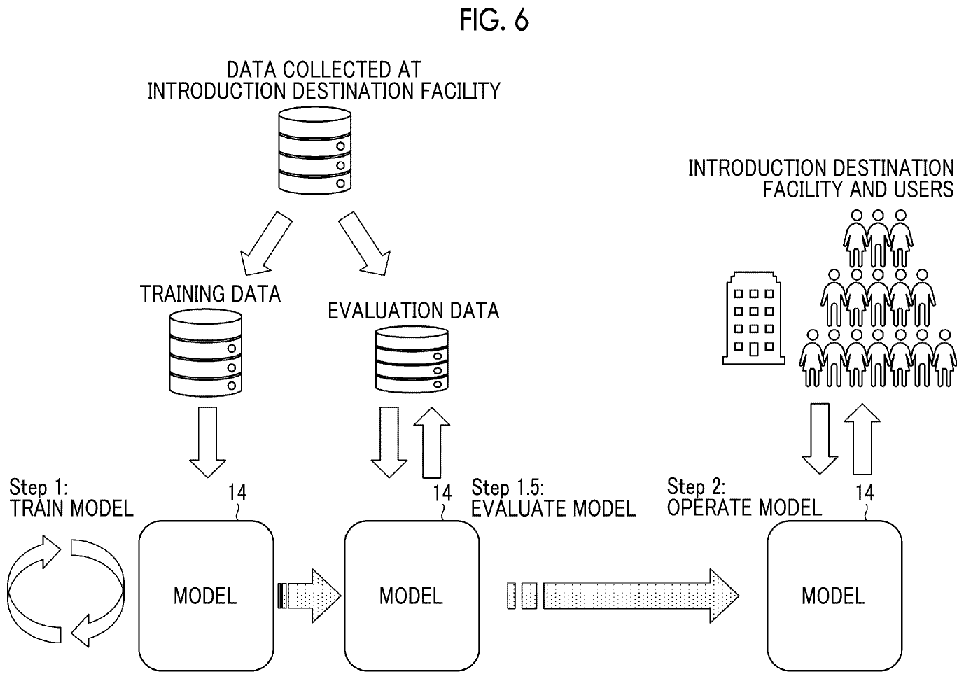

FIG. 6 is an explanatory diagram of an introduction flow of the suggestion system including a step of evaluating the performance of the trained model 14. In FIG. 6, a step of evaluating the performance of the model 14 is added as “step 1.5” between Step 1 (the step of training the model 14) and Step 2 (the step of operating the model 14) described in FIG. 5. Other configurations are the same as in FIG. 5. As shown in FIG. 6, in a general introduction flow of the suggestion system, the data, which is collected at the introduction destination facility, is often divided into training data and evaluation data. The prediction performance of the model 14 is checked by using the evaluation data, and then the operation of the model 14 is started.

However, in a case of building the model 14 of domain generalization, the training data and the evaluation data need to be different domains. Further, in the domain generalization, it is preferable to use the data of a plurality of domains as the training data, and it is more preferable that there are many domains that can be used for a training.

Regarding Generalization

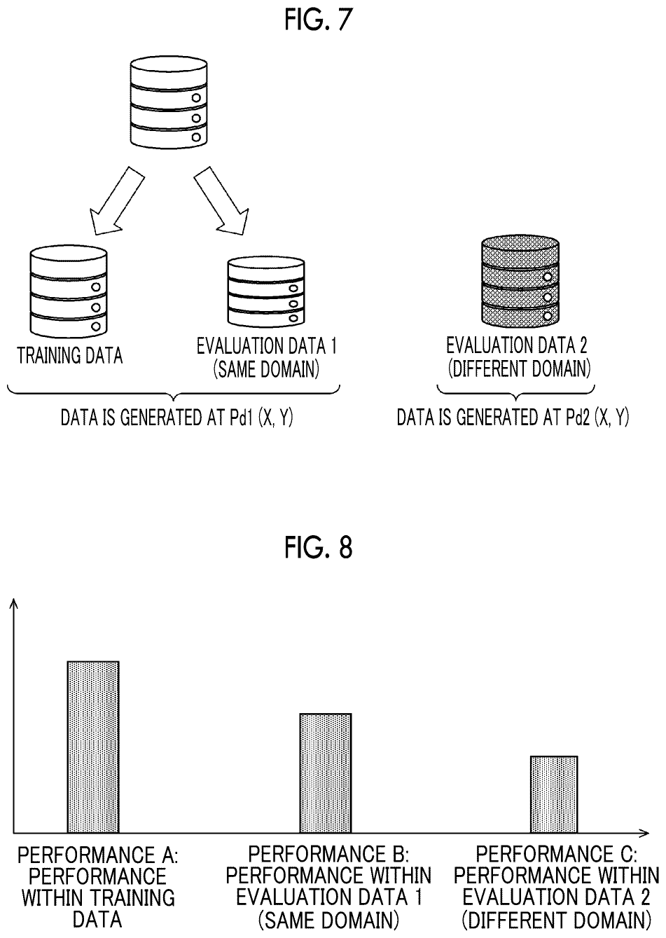

FIG. 7 is an explanatory diagram showing an example of the training data and the evaluation data used for the machine learning. The dataset obtained from the simultaneous probability distribution Pd1(X, Y) of a certain domain d1 is divided into training data and evaluation data. The evaluation data of the same domain as the training data is referred to as “first evaluation data” and is referred to as “evaluation data 1” in FIG. 7. Further, a dataset, which is obtained from a simultaneous probability distribution Pd2(X, Y) of a domain d2 different from the domain d1, is prepared and is used as the evaluation data. The evaluation data of the domain different from the training data is referred to as “second evaluation data” and is referred to as “evaluation data 2” in FIG. 7.

The model 14 is trained by using the training data of the domain d1, and the performance of the model 14, which is trained by using each of the first evaluation data of the domain d1 and the second evaluation data of the domain d2, is evaluated.

FIG. 8 is a graph schematically showing a difference in performance of the model due to a difference in the dataset. Assuming that the performance of the model 14 in the training data is defined as performance A, the performance of the model 14 in the first evaluation data is defined as performance B, and the performance of the model 14 in the second evaluation data is defined as performance C, normally, a relationship is represented such that performance A>performance B>performance C, as shown in FIG. 8.

High generalization performance of the model 14 generally indicates that the performance B is high, or indicates that a difference between the performances A and B is small. That is, the aim is to achieve high prediction performance even for untrained data without over-fitting to the training data.

In the context of domain generalization in the present specification, it means that the performance C is high or a difference between the performance B and the performance C is small. In other words, the aim is to achieve high performance consistently even in a domain different from the domain used for the training.

In the present embodiment, although the data of the introduction destination facility cannot be used in a case where the model 14 is trained, it is assumed that a status where data (correct answer data) including the behavior history collected at the introduction destination facility can be prepared in a case where the model is evaluated before introduction (evaluation before introduction).

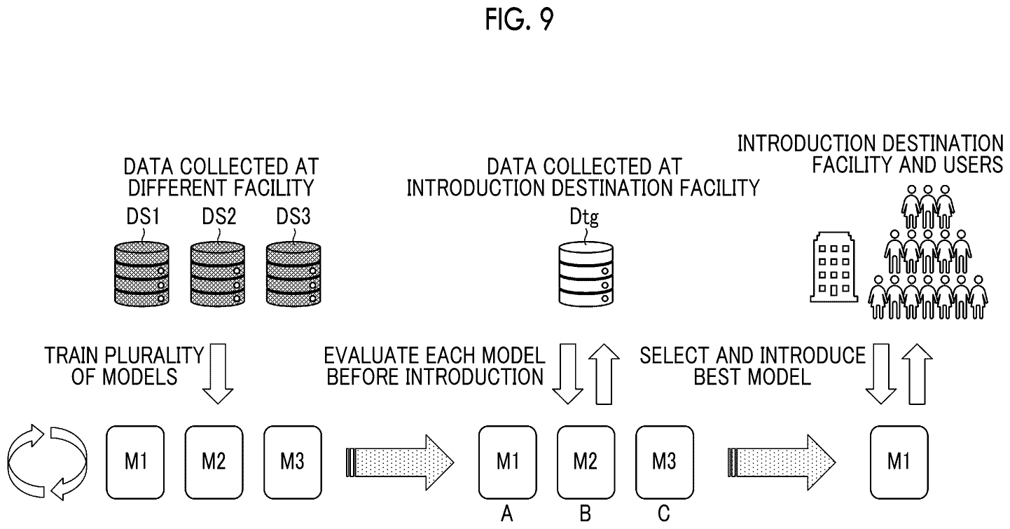

In such cases, by generating a plurality of candidate models by training the model by using the data collected at a facility different from the introduction destination facility and by evaluating the performance of each candidate model by using the data collected at the introduction destination facility before the introduction, it is conceivable to select the optimal model from among the plurality of candidate models and apply the optimal model to the introduction destination facility based on the results of the evaluation. An example thereof is shown in FIG. 9.

FIG. 9 is an explanatory diagram showing an example of an introduction flow of the suggestion system in a case where a learning domain and an introduction destination domain are different from each other. As shown in FIG. 9, a plurality of models can be trained by using the data collected at a facility different from the introduction destination facility. Here, an example is shown in which training of models M1, M2, and M3 is performed by using datasets DS1, DS2, and DS3 collected at different facilities. For example, the model M1 is trained by using the dataset DS1, the model M2 is trained by using the dataset DS2, and the model M3 is trained by using the dataset DS3. The dataset used for training each of the models M1, M2, and M3 may be a combination of a plurality of datasets collected at different facilities. For example, the model M1 may be trained by using a dataset in which the dataset DS1 and the dataset DS2 are mixed.

In this way, after the plurality of models M1, M2, and M3 are trained, the performance of each of the models M1, M2, and M3 is evaluated by using data Dtg collected at the introduction destination facility. In FIG. 9, the symbols “A”, “B”, and “C” shown below the respective models M1, M2, and M3 represent the evaluation results of the respective models. Evaluation A indicates good prediction performance that satisfies an introduction standard. Evaluation B indicates that the performance is inferior to Evaluation A. Evaluation C indicates that the performance is inferior to Evaluation B and is not suitable for introduction.

For example, as shown in FIG. 9, assuming that the evaluation result of the model M1 is defined as “A”, the evaluation result of the model M2 is defined as “B”, and the evaluation result of model M3 is defined as “C”, the model M1 is selected as the optimal model at the introduction destination facility, and the suggestion system 10 to which the model M1 is applied is introduced.

Problems

As described in FIG. 9, even in a case where the data of the introduction destination facility cannot be obtained at the time of a model learning, in a case where the data that is collected at the introduction destination facility is present at the time of the introduction, the data can be used to evaluate models and the best model can be selected.

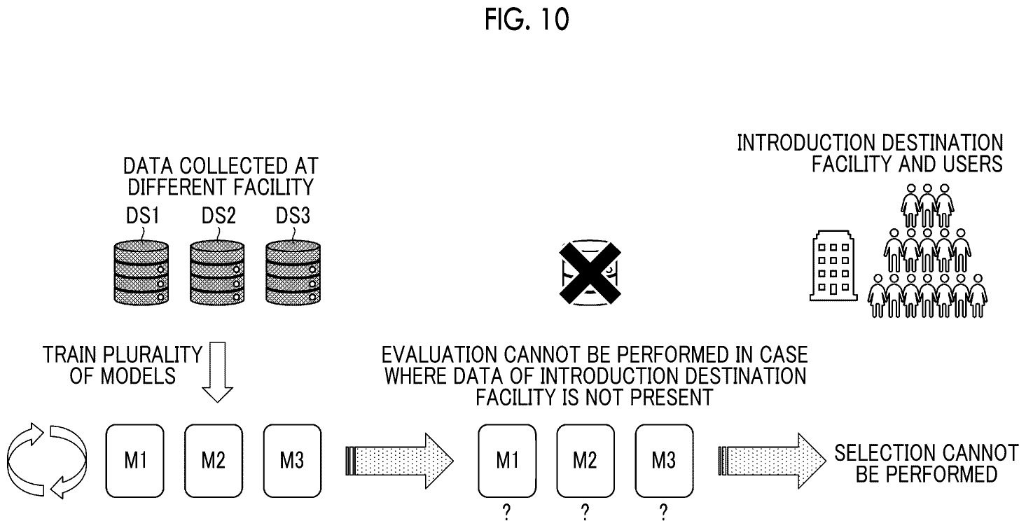

However, the model cannot be selected in a case where the data of the introduction destination facility is not present even at the time of introduction, or in a case where access is not possible even in a case where the data is present. That is, as shown in FIG. 10, in a case where the data of the introduction destination facility is not present, each of the models M1, M2, and M3 cannot be evaluated, and the best model cannot be selected.

As described above, in a case where the data of the introduction destination facility cannot be used even in the evaluation before introduction of the model, the best model for the introduction destination cannot be selected. Even in such a case, it is desired to make a high performance recommendation at the introduction destination facility. Since the learning domain and the introduction destination domain are different, it is a problem to realize a robust recommendation for the domain shift. In the present embodiment, an information processing method and an information processing apparatus capable of creating a robust single model are provided.

Local Model

FIG. 11 is a diagram showing the dataset according to the present embodiment. The dataset is data for each facility in which a behavior of a user on an item for each of combinations of a plurality of users and a plurality of items is indicated. In the example shown in FIG. 11, the dataset indicates a matrix where the vertical axis represents users and the horizontal axis represents items, and the individual cells indicate a behavior of a user on an item.

In Case of Federated Learning

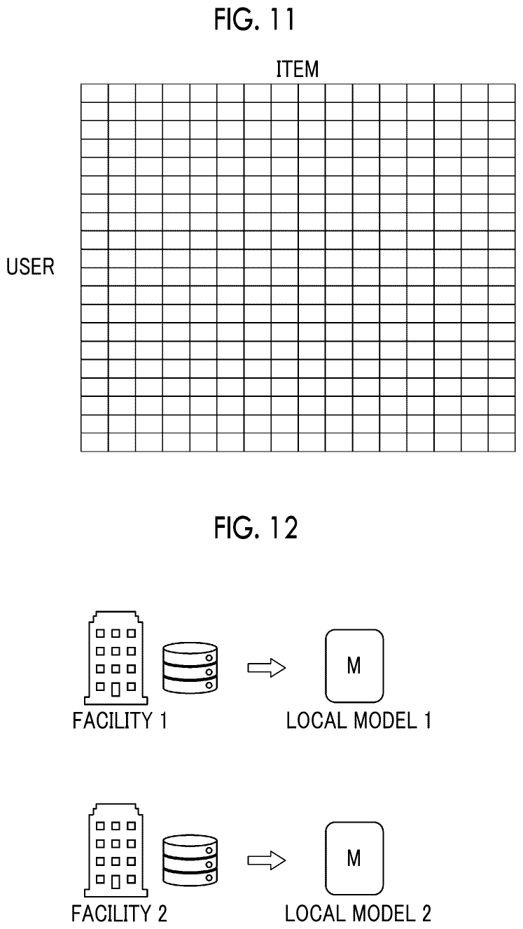

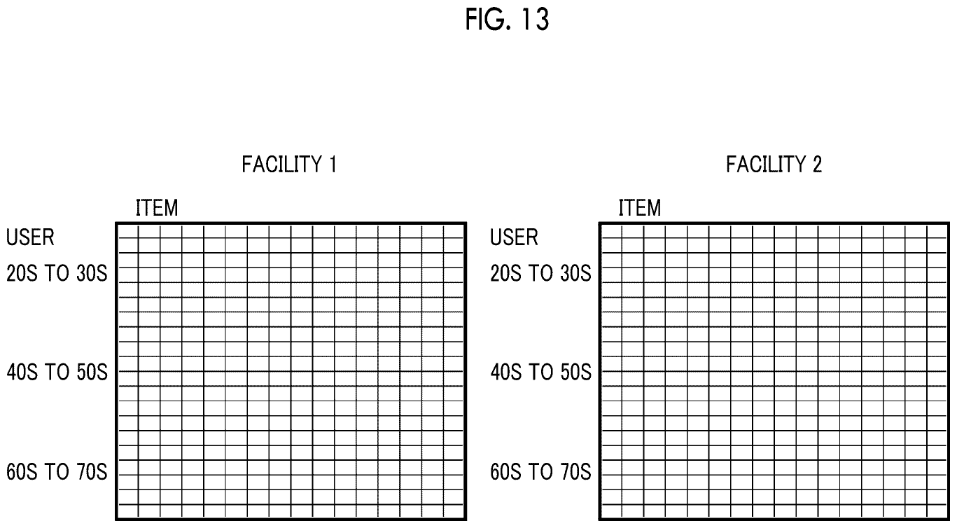

In the context of federated learning, a model, which is built from the data of each facility, is called a local model. FIGS. 12 and 13 are diagrams illustrating a local model in the federated learning. FIG. 12 shows that a model that is built from a dataset of a “facility 1” is a “local model 1” and a model that is built from a dataset of a “facility 2” is a “local model 2”. In this way, different local models are built between the “facility 1” and the “facility 2”.

FIG. 13 shows a dataset of a “facility 1” and a dataset of a “facility 2”. The local models that differ between facilities are common among subgroups of users. That is, in the example shown in FIG. 13, in the “facility 1”, the three subgroups, in which the age of the users are in 20s to 30s, 40s to 50s, and 60s to 70s, are common in the same “local model 1” (see FIG. 12). Further, in the “facility 2”, the three subgroups, in which the age of the users are in 20s to 30s, 40s to 50s, and 60s to 70s, are common in the same “local model 2” (see FIG. 12).

In Case of Present Disclosure

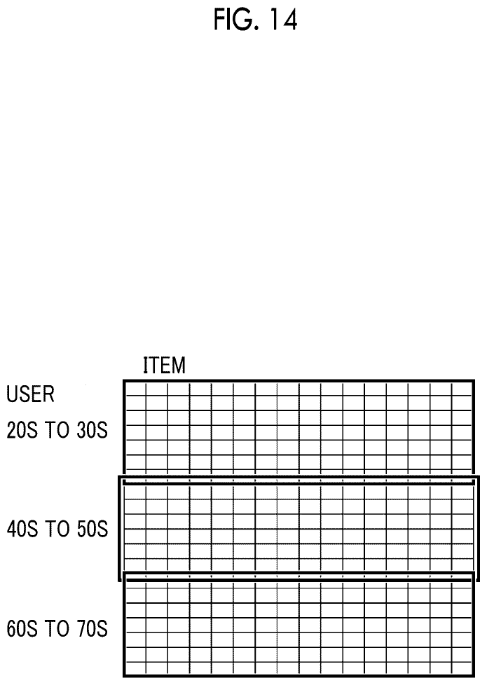

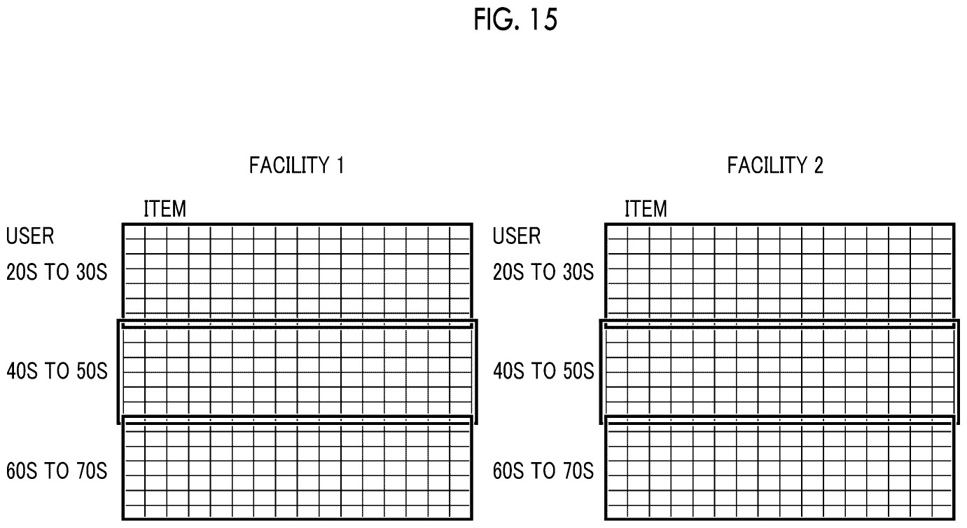

In the context of the present disclosure, a model, which is built for each subgroup of users and items is referred to as a local model. FIGS. 14 and 15 are diagrams of a dataset illustrating a local model in the present disclosure. In the example shown in FIG. 14, the dataset is divided into three subgroups in which the age of the users are in 20s to 30s, 40s to 50s, and 60s to 70s. In the present disclosure, a model, which is built for each subgroup, is referred to as a local model.

Here, the local models that differ between the subgroups are common among the facilities. That is, as shown in FIG. 15, the local model, which is built with the subgroup in which the age of the users are in 20s to 30s, is common to each of the “facility 1” and the “facility 2”. Similarly, the local model, which is built with the subgroup in which the age of the users are in 40s to 50s, and the local model, which is built with the subgroup in which the age of the users are in 60s to 70s, are both common to each of the “facility 1” and the “facility 2”.

Outline of Information Processing Apparatus According to Embodiment

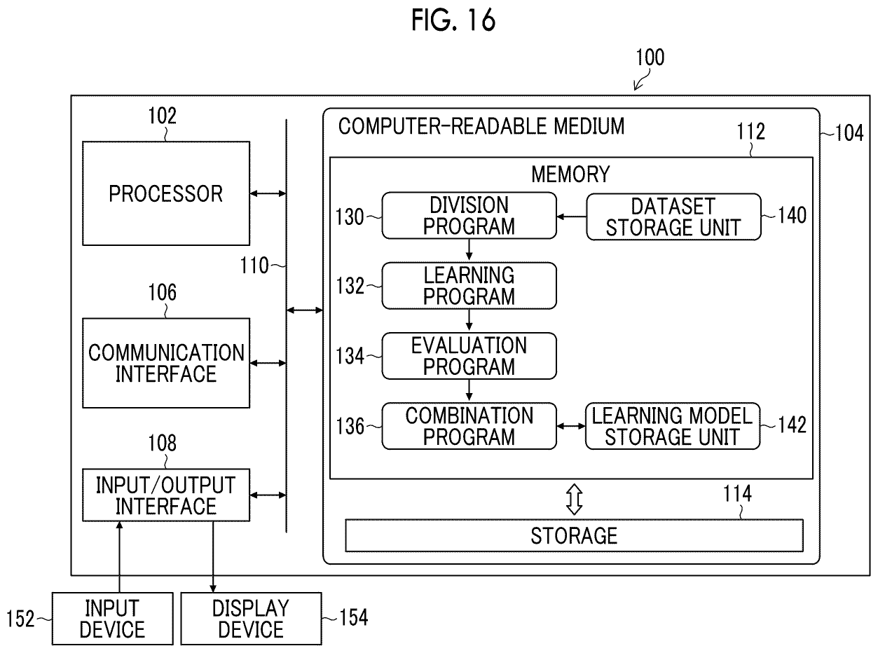

FIG. 16 is a block diagram schematically showing an example of a hardware configuration of an information processing apparatus 100 according to an embodiment. The information processing apparatus 100 includes a function of dividing a dataset, which indicates a behavior of a user on an item for each of combinations of a plurality of the users and a plurality of the items, into a plurality of subgroups that are robust with respect to domain shift, a function of generating a local model for performing a prediction of the behavior of the user on the item for each of the subgroups, and a function of combining a plurality of the local models generated for each of the subgroups.

The information processing apparatus 100 can be realized by using hardware and software of a computer. The physical form of the information processing apparatus 100 is not particularly limited, and may be a server computer, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 via the bus 110. The processor 102 reads out various programs, data, and the like stored in the computer-readable medium 104 and executes various processes. The term program includes the concept of a program module and includes instructions conforming to the program.

The computer-readable medium 104 is, for example, a storage device including a memory 112 which is a main memory and a storage 114 which is an auxiliary storage device. The storage 114 is configured using, for example, a hard disk drive (HDD) device, a solid state drive (SSD) device, an optical disk, a photomagnetic disk, a semiconductor memory, or an appropriate combination thereof. Various programs, data, and the like are stored in the storage 114.

The memory 112 is used as a work area of the processor 102 and is used as a storage unit that temporarily stores the program and various types of data read from the storage 114. By loading the program that is stored in the storage 114 into the memory 112 and executing instructions of the program by the processor 102, the processor 102 functions as a unit for performing various processes defined by the program.

The memory 112 stores a division program 130, a learning program 132, an evaluation program 134, a combination program 136, various programs, various types of data, and the like executed by the processor 102.

The division program 130 is a program for executing processing of acquiring the dataset indicating the behavior of the user on the item for each of the combinations of the plurality of users and the plurality of items and dividing the acquired dataset into the plurality of subgroups that are robust with respect to the domain shift.

The learning program 132 is a program for executing processing of training a local model, which is a prediction model for predicting the behavior of the user on the item for each subgroup divided by using the division program 130.

The evaluation program 134 is a program for executing processing of evaluating the robustness of the plurality of local models, which are trained by using the learning program 132, with respect to the domain shift.

The combination program 136 is a program for executing processing of combining the plurality of local models trained by using the learning program 132. The combination program 136 may generate a model in which the plurality of local models are combined or may combine outputs of each of the plurality of local models. The evaluation program 134 may evaluate the robustness of a model in which the plurality of local models are combined.

The memory 112 includes a dataset storage unit 140 and a learning model storage unit 142. The dataset storage unit 140 is a storage region that stores a dataset collected at a learning facility, which is a dataset that indicates the behavior of the user on the item for each of the combinations of the plurality of users and the plurality of items. The learning model storage unit 142 is a storage region in which the plurality of local models, which are combined by using the combination program 136, are stored.

The communication interface 106 performs a communication process with an external apparatus by wire or wirelessly and exchanges information with the external apparatus. The information processing apparatus 100 is connected to a communication line (not shown) via the communication interface 106. The communication line may be a local area network, a wide area network, or a combination thereof. The communication interface 106 can play a role of a data acquisition unit that receives input of various data such as the original dataset. The information processing apparatus 100 may include an input device 152 and a display device 154. The input device 152 and the display device 154 are connected to the bus 110 via the input/output interface 108. The input device 152 may be, for example, a keyboard, a mouse, a multi-touch panel, or other pointing device, a voice input device, or an appropriate combination thereof. The display device 154 may be, for example, a liquid crystal display, an organic electro-luminescence (OEL) display, a projector, or an appropriate combination thereof. The input device 152 and the display device 154 may be integrally configured as in the touch panel, or the information processing apparatus 100, the input device 152, and the display device 154 may be integrally configured as in the touch panel type tablet terminal.

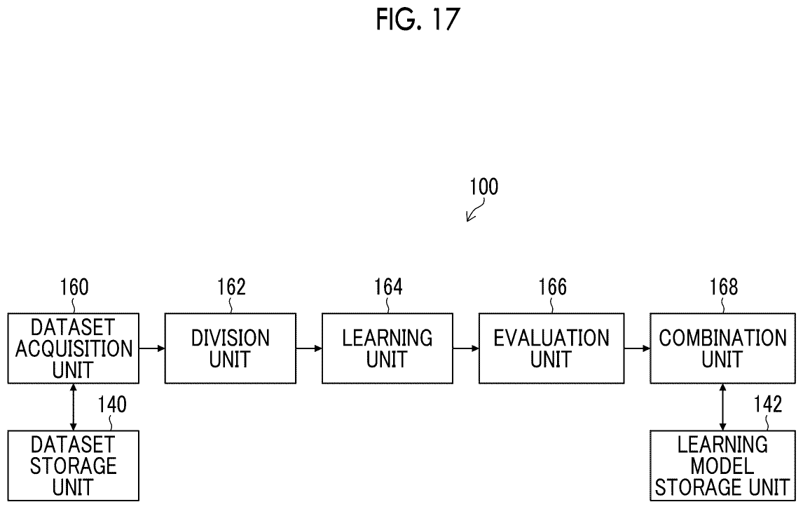

FIG. 17 is a functional block diagram showing a functional configuration of an information processing apparatus 100. The information processing apparatus 100 includes a dataset acquisition unit 160, a division unit 162, a learning unit 164, an evaluation unit 166, and a combination unit 168.

The dataset acquisition unit 160 acquires the dataset collected at the learning facility from the dataset storage unit 140.

The division unit 162 divides the dataset, which is acquired by the dataset acquisition unit 160, into the plurality of subgroups that are robust with respect to the domain shift.

The learning unit 164 generates a local model, which is a prediction model for predicting the behavior of the user on the item for each subgroup divided by the division unit 162.

The evaluation unit 166 evaluates the robustness of the plurality of local models, which are trained by the learning unit 164, with respect to the domain shift.

The combination unit 168 combines a plurality of local models trained by the learning unit 164. The plurality of local models are stored in the learning model storage unit 142 as learning models.

Specific Example of Behavior History

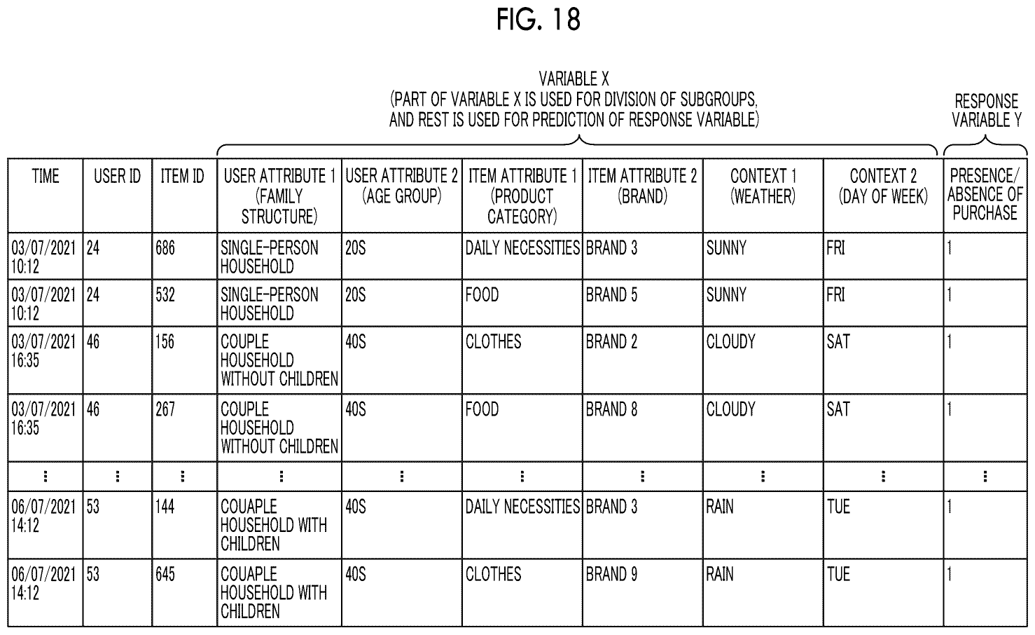

FIG. 18 is a chart showing an example of behavior history data that is a basis of the dataset. Here, a case of a behavior history in a sales system in a retail company is considered. FIG. 18 shows an example of a table of a user behavior history related to purchase of products obtained from the sales system of a certain retail company. The “item” here is a product. The table shown in FIG. 18 includes columns of “time”, “user ID”, “item ID”, “user attribute 1”, “user attribute 2”, “item attribute 1”, “item attribute 2”, “context 1”, “context 2”, and “presence/absence of purchase”.

The “time” is the date and time when the item is purchased. The “user ID” is an identification code that specifies a user, and an identification (ID) that is unique to each user is defined. The item ID is an identification code that specifies an item, and an ID that is unique to each item is defined. The “user attribute 1” is, for example, a “family structure”. The “user attribute 2” is, for example, an “age group”. The “family structure” and the “age group” are examples of attribute data, respectively. The “item attribute 1” is, for example, a “product category”. The “item attribute 2” is, for example, a “brand”. The “product category” and the “brand” are examples of attribute data of the item, respectively. The “context 1” is, for example, “weather”. The “context 2” is, for example, a “day of the week”. The “weather” and the “day of the week” are examples of attribute data of the context, respectively.

The “presence/absence of purchase” is an example of a “behavior of a user on an item”, and a value in a case where the item is purchased (purchase is present) is “1”. Since the number of items that are not purchased is enormous, it is common to record only the purchased item (presence/absence of purchase=1) in the record. The table of the behavior history may include a column of an “evaluation value” instead of the “presence/absence of purchase” as the behavior of the user on the item.

The “presence/absence of purchase” in FIG. 18 is an example of the response variable Y, and each of the “user attribute 1”, “user attribute 2”, “item attribute 1”, “item attribute 2”, “context 1”, and “context 2” is an example of the explanatory variable X. The number of types of the explanatory variables X and the combination thereof are not limited to the example in FIG. 18. The explanatory variable X may further include a user attribute 3, an item attribute 3, a context 3, and the like (not shown). A part of the explanatory variable X is used for the division of subgroups, and the rest is used for prediction of the response variable.

Outline of Information Processing Method

The present disclosure divides the dataset, in which the behavior of the user on the item for each of the combinations of the plurality of users and the plurality of items is indicated, into the subgroups.

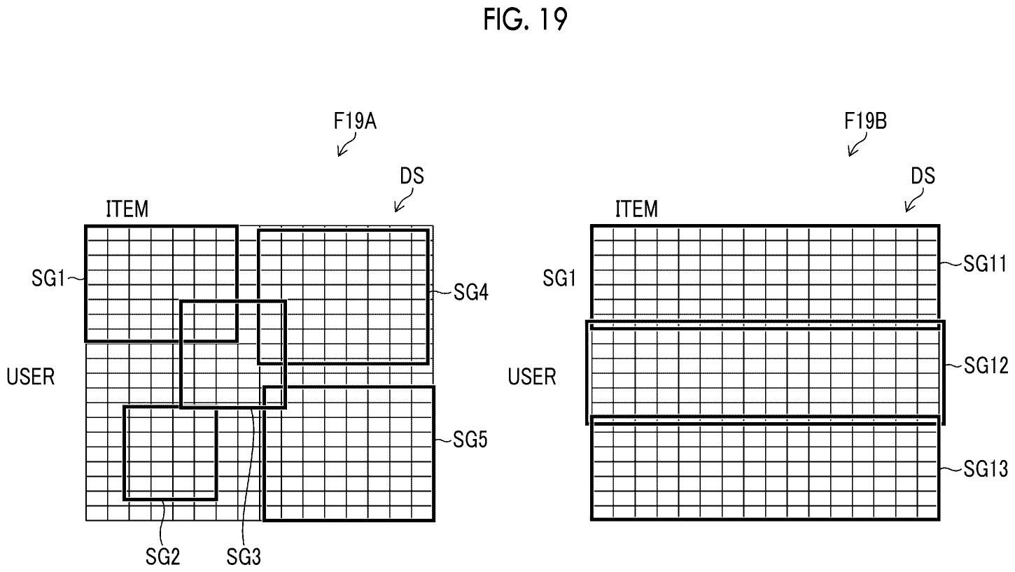

FIG. 19 is a diagram illustrating the division of the subgroups. F19A in FIG. 19 shows an example in which the dataset DS, which is represented in a two-dimensional matrix where the vertical axis represents users and the horizontal axis represents items, is divided into five subgroups SG1, SG2, SG3, SG4, and SG5. Further, F19B in FIG. 19 shows an example in which the dataset DS is divided into three subgroups SG11, SG12, and SG13. In the division of subgroups, a portion of the matrix of the dataset DS may be included in the plurality of subgroups in an overlapped manner, and the portion may not be included in any subgroup.

In the dataset DS, the vertical axis representing the users is not in the order of user IDs, but the users are arranged in the order of any user attribute data. For example, in a case of dividing the dataset DS into the subgroups by using the attribute data of the age group of the user, the users are arranged in the order of the age groups of the users in the dataset DS.

Similarly, in the dataset DS, the vertical axis representing the items is not in the order of item IDs, but the items are arranged in the order of any item attribute data. For example, in a case of dividing the dataset DS into the subgroups by using the attribute data of the product category of the item, the items are arranged in the order of the product categories of the items in the dataset DS.

The subgroups are divided such that the subgroups are robust with respect to the domain shift, that is, a robust partial model can be built. Although it is difficult to build a single model that is robust with respect to the domain shift with respect to all combinations of the users and the items, it is relatively easy to build a robust model in well-divided subgroups. For example, a partial model for a surgeon for a patient with ∘∘ disease, a partial model for a couple with one child in their 30s, and the like.

### Embodiment 1

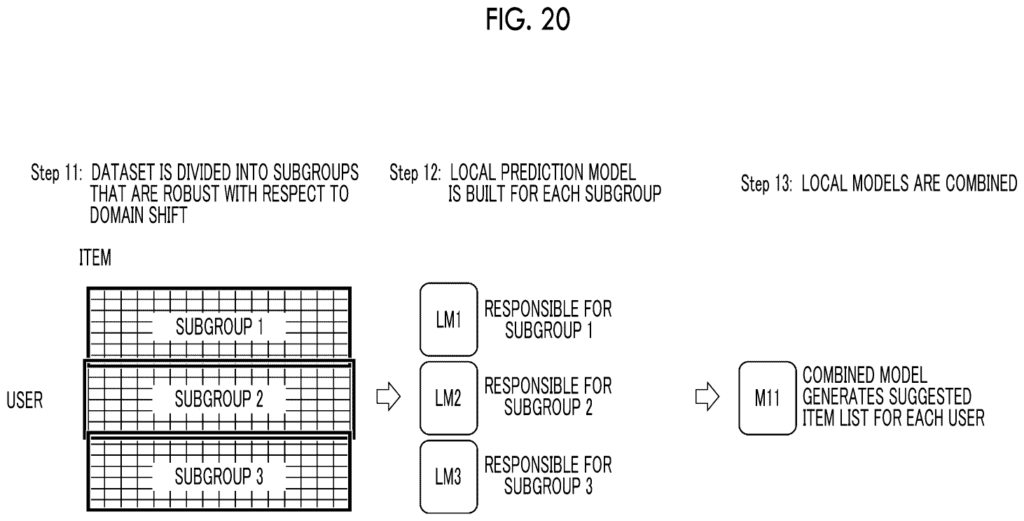

FIG. 20 is an explanatory diagram showing an information suggestion flow according to Embodiment 1.

First, in step 11, the dataset is divided into the subgroups. That is, the dataset acquisition unit 160 acquires the dataset in which the behavior of the user on the item for each of the combinations of the plurality of users and the plurality of items is indicated. The dataset is generated based on the data of the behavior of the user on the item collected at a certain single facility (domain). The division unit 162 divides the acquired dataset into the plurality of subgroups that are robust with respect to the domain shift.

The division unit 162 divides the dataset based on at least one of the attribute data of the user or the attribute data of the item. As shown in FIG. 20, here, it is divided into three subgroups of a “subgroup 1”, a “subgroup 2”, and a “subgroup 3”.

In step 12, a local model, which is a local prediction model, is built for each subgroup. In the example shown in FIG. 20, the learning unit 164 builds a local model LM1 by using data of the “subgroup 1”, builds a local model LM2 by using data of the “subgroup 2”, and builds a local model LM3 by using data of the “subgroup 3”. That is, the local model LM1 is a prediction model responsible for predicting the “subgroup 1”, the local model LM2 is a prediction model responsible for predicting the “subgroup 2”, and the local model LM3 is a prediction model responsible for predicting the “subgroup 3”, respectively.

In step 13, a plurality of built local models are combined. That is, the combination unit 168 combines the local models LM1, LM2, and LM3 to generate a model M11. With this model M11, a suggested item list can be generated for each user. The suggested item list for each user may be generated by combining the output of each of the local models LM1, LM2, and LM3. The suggested item list, which is generated by using the combined model M11, and the suggested item list, which is generated by combining the output of each of the local models LM1, LM2, and LM3, are mathematically equivalent.

According to Embodiment 1, since the dataset is divided into the plurality of subgroups that are robust with respect to the domain shift, and the local model is built for each subgroup, a local model that is robust with respect to the domain shift is built. Therefore, it is possible to provide a high performance suggested item list by combining the plurality of local models. In a case where the local model, which is generated based on the subgroup, is robust with respect to the domain shift, it can be said that the subgroup is robust with respect to the domain shift.

### Embodiment 2

The dataset may be data for each facility in which the behavior of the user on the item for each of the combinations of the plurality of users, the plurality of items, and the plurality of contexts is indicated. In this case, the division unit 162 may divide the dataset based on at least one of the attribute data of the context.

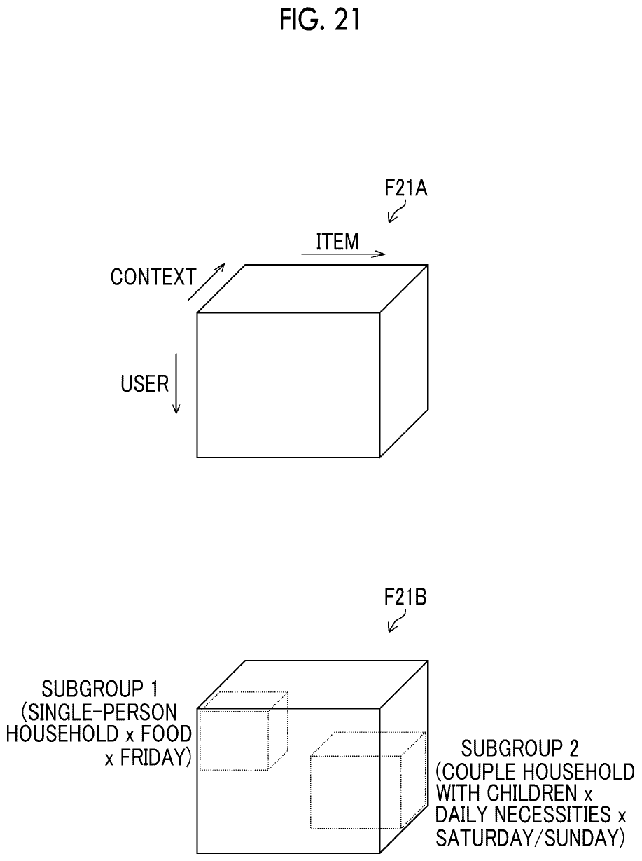

FIG. 21 is a diagram illustrating a dataset of combinations of users, items, and contexts. As shown in F21A, a combination of users, items, and contexts can be represented in a three-dimensional matrix. On the axis indicating the context, the contexts are arranged in the order of the attribute data of the contexts. For example, the contexts are arranged in the order of the day of the week in a case where the items were purchased.

F21B illustrates an example of subgroup division of the dataset of combinations of users, items, and contexts. In the example shown in F21B, in the “subgroup 1”, the user attribute is “single-person household”, the item attribute is “food”, and the context is “Friday”. Further, in the “subgroup 2” shown in F21B, the user attribute is “a couple household with children”, the item attribute is “daily necessities”, and the context is “Saturday/Sunday”.

### Embodiment 3

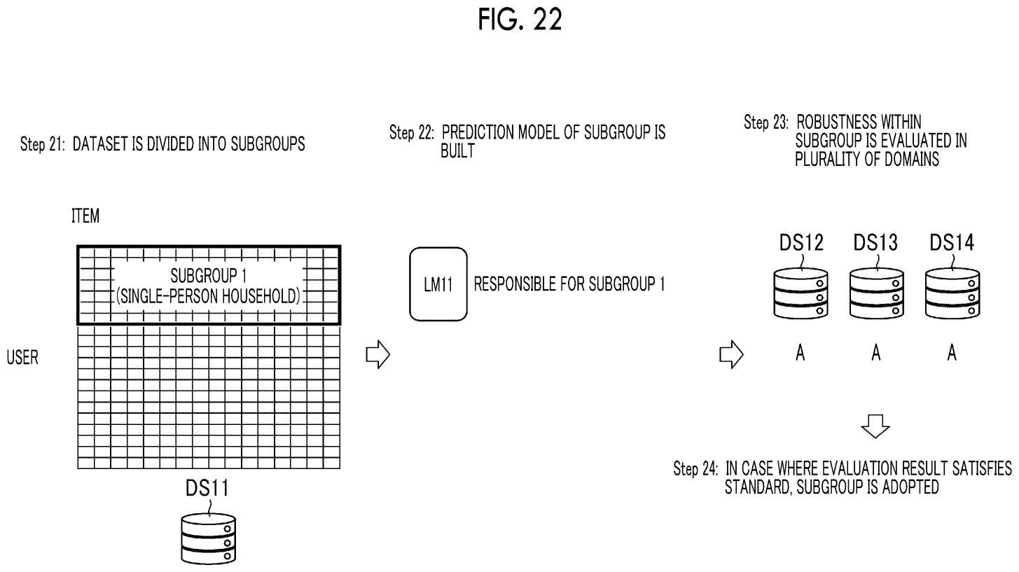

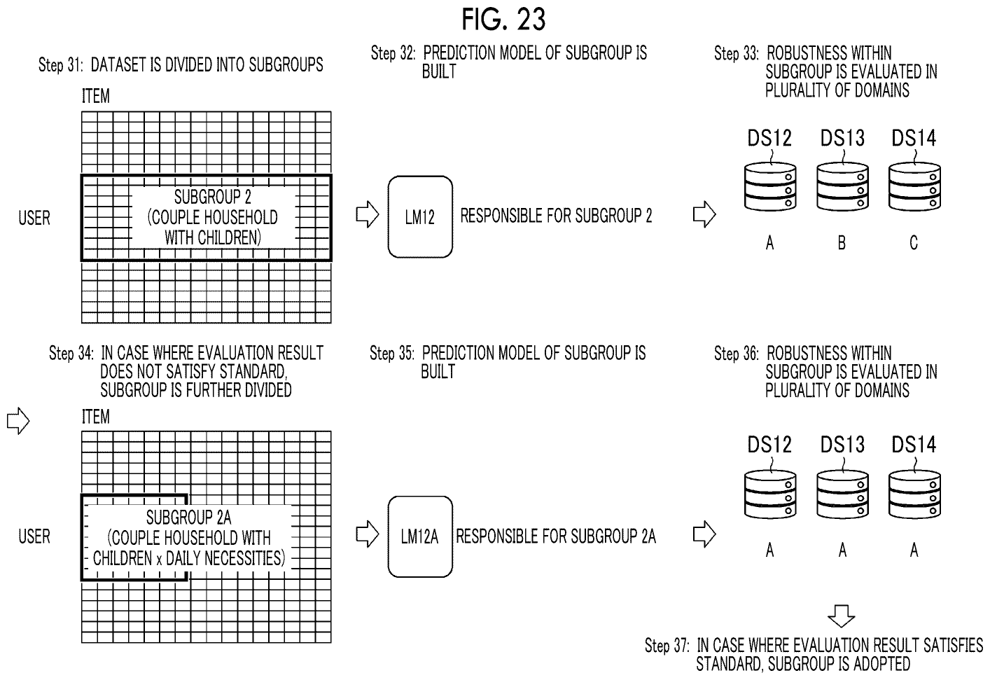

FIGS. 22 and 23 are explanatory diagrams showing a subgroup division flow according to Embodiment 3.

In step 21, the dataset is divided into the subgroups. That is, the dataset acquisition unit 160 acquires the dataset, and the division unit 162 divides the acquired dataset into the subgroups. Here, the dataset acquisition unit 160 acquires a dataset DS11 of a certain facility, and the division unit 162 performs division of the “subgroup 1 (single-person household)” in which the user attribute is “single-person household” from the dataset.

In step 22, a prediction model of the subgroup is built. That is, the learning unit 164 builds a local model LM11 by using the data of the “subgroup 1 (single-person household)”.

In step 23, the robustness within the subgroup is evaluated in the plurality of domains. In the example shown in FIG. 22, the evaluation unit 166 evaluates the robustness of the local model LM11 by using the datasets DS12, DS13, and DS14, which are facilities other than the facility of the dataset DS11 and which are different facilities from each other.

The local model LM11 is built based on the “subgroup 1 (single-person household)” in which the user attribute is “single-person household”, in the dataset DS11. Therefore, the evaluation unit 166 evaluates the robustness of the local model LM11 by using each of the subgroups in which the user attribute is “single-person household” in the datasets DS12, DS13, and DS14.

In FIG. 23, a symbol “A” below each of the datasets DS12, DS13, and DS14 represents an evaluation result obtained from each dataset. Evaluation A indicates good robustness that satisfies an introduction standard. For example, in a case where a difference between prediction performance of the local model LM11 with respect to the dataset DS11 and prediction performance of the local model LM11 with respect to the dataset DS12 is relatively small, the evaluation result obtained from the dataset DS12 is Evaluation A. Although not shown in FIG. 23, Evaluation B represented with the symbol “B” indicates that the performance is inferior to Evaluation A. Further, Evaluation C represented with the symbol “C” is performance inferior to Evaluation B and indicates that the performance is not suitable for introduction. Here, each of the robustness of the local model LM11 obtained by using the datasets DS12, DS13, and DS14 is Evaluation A.

In step 24, in a case where the evaluation result satisfies the standard, the subgroup is adopted. That is, the evaluation unit 166 compares the evaluation standard with the evaluation result in step 23. For the evaluation standard, for example, “all the robustness obtained by using each dataset is Evaluation A”. In a case where the evaluation result satisfies the evaluation standard, it can be said that the “subgroup 1 (single-person household)” is robust with respect to the domain shift. Here, all the robustness of the local model LM11 obtained by using the datasets DS12, DS13, and DS14, is Evaluation A and satisfies the evaluation standard. Therefore, the evaluation unit 166 adopts the “subgroup 1 (single-person household)” as a subgroup.

As described above, in Embodiment 3, in the case of dividing the dataset into subgroups in step 21, it is unclear whether or not the subgroup is robust with respect to the domain shift. However, as a result of the evaluation in step 23, as it was found that the subgroups are robust with respect to the domain shift, in step 21 dividing the dataset into subgroups is synonymous with dividing the dataset into the plurality of subgroups that are robust with respect to the domain shift.

Subsequently, in step 31, the dataset is further divided into subgroups. In the example shown in FIG. 23, the division unit 162 performs division of the “subgroup 2 (couple household with children)” in which the user attribute is “couple household with children” from the dataset.

In step 32, a prediction model of the subgroup is built. That is, the learning unit 164 builds a local model LM12 by using the data of the “subgroup 2 (couple household with children)”.

In step 33, the robustness within the subgroup is evaluated in the plurality of domains. That is, similar to step 23, the evaluation unit 166 evaluates the robustness of the local model LM12 by using the datasets DS12, DS13, and DS14.

The local model LM12 is built based on the “subgroup 2 (couple household with children)” in which the user attribute is “couple household with children”, in the dataset DS11. Therefore, the evaluation unit 166 evaluates the robustness of the local model LM12 by using each of the subgroups in which the user attribute is “couple household with children” in the datasets DS12, DS13, and DS14. Here, the robustness of the local models LM12 obtained by using the datasets DS12, DS13, and DS14 are each Evaluation A, Evaluation B, and Evaluation C.

In step 34, in a case where the evaluation result satisfies the standard, the subgroup is adopted, and in a case where the evaluation result does not satisfy the standard, the subgroup is further divided. That is, the evaluation unit 166 compares the evaluation standard with the evaluation result in step 33. Here, the evaluation standard is not satisfied. Therefore, the division unit 162 performs division of a “subgroup 2A (couple household with children x daily necessities)” in which the context is “daily necessities” from the “subgroup 2 (couple household with children)”.

In step 35, a prediction model of the subgroup is built. That is, the learning unit 164 builds a local model LM12A by using the data of the “subgroup 2A (couple household with children x daily necessities)”.

In step 36, the robustness within the subgroup is evaluated in the plurality of domains. That is, the evaluation unit 166 evaluates the robustness of the local model LM12A by using each of the subgroups in which the user attribute is “couple household with children” and the context is “daily necessities” in the datasets DS12, DS13, and DS14. Here, all the robustness of the local model LM12A obtained by using the datasets DS12, DS13, and DS14 is Evaluation A.

In step 37, in a case where the evaluation result satisfies the standard, the subgroup is adopted. In a case where the evaluation result satisfies the evaluation standard, it can be said that the “subgroup 2A (couple household with children x daily necessities)” is robust with respect to the domain shift. Here, all the robustness of the local model LM12A obtained by using the datasets DS12, DS13, and DS14, is Evaluation A and satisfies the evaluation standard. Therefore, the evaluation unit 166 adopts the “subgroup 2A (couple household with children x daily necessities)” as a subgroup.

The above processing is repeated, and in a case where the subgroup division that satisfies the desired condition is found, the subgroup search is ended. The desired conditions are as follows.

A condition example 1 is that each user belongs to one or more subgroups. In practice, the majority of users need only belong to one or more subgroups. The majority of the users are, for example, 80% or more of the users, and more preferably 90% or more of the users. Personalized recommendations may be provided to users who belong to the subgroup, and non-personalized recommendations may be provided to users who do not belong to the subgroup. The non-personalized recommendation is, for example, a recommendation such as the top 10 popular items.

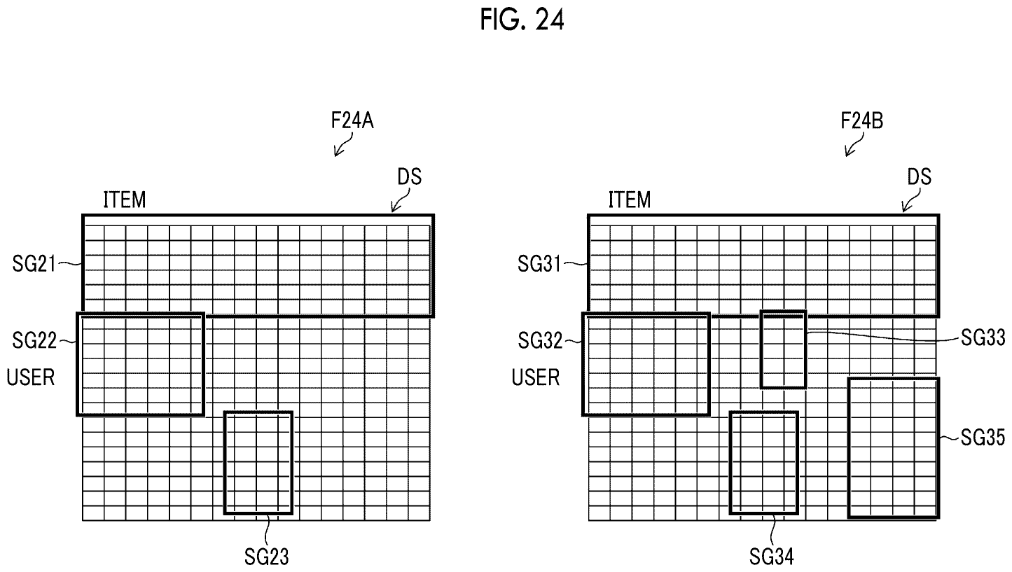

FIG. 24 is a diagram showing an example of the subgroup division. In the example shown in F24A, the dataset is divided into three subgroups SG21, SG22, and SG23, and each user belongs to any one of the subgroups SG21, SG22, and SG23, thereby the condition example 1 is satisfied.

A condition example 2 is that each user includes at least a certain number (for example, half) or more of items. In practice, the majority of the users may include a certain number or more of items. The majority of the users are, for example, 80% or more of the users, and more preferably 90% or more of the users. In a case where the number of suggested items is 10, a certain number or more of items is, for example, 100 or more items, which is 10 times, and more preferably is 1000 or more items, which is 100 times the number of suggested items. The sufficient number of candidate items also depends on the total number of items and the number of suggested items. As the number of suggested items per user is relatively large, it is preferable that the number of candidate items is relatively large. Further, in a case where the total number of items is relatively small, it is difficult to increase the number of candidate items relatively, so that the number of candidate items may be relatively small.

In the example shown in F24B in FIG. 24, the dataset is divided into subgroups SG31, SG32, SG33, SG34, and SG35, which are five subgroups, and each user includes at least half or more items, thereby the condition example 2 is satisfied.

### Embodiment 4

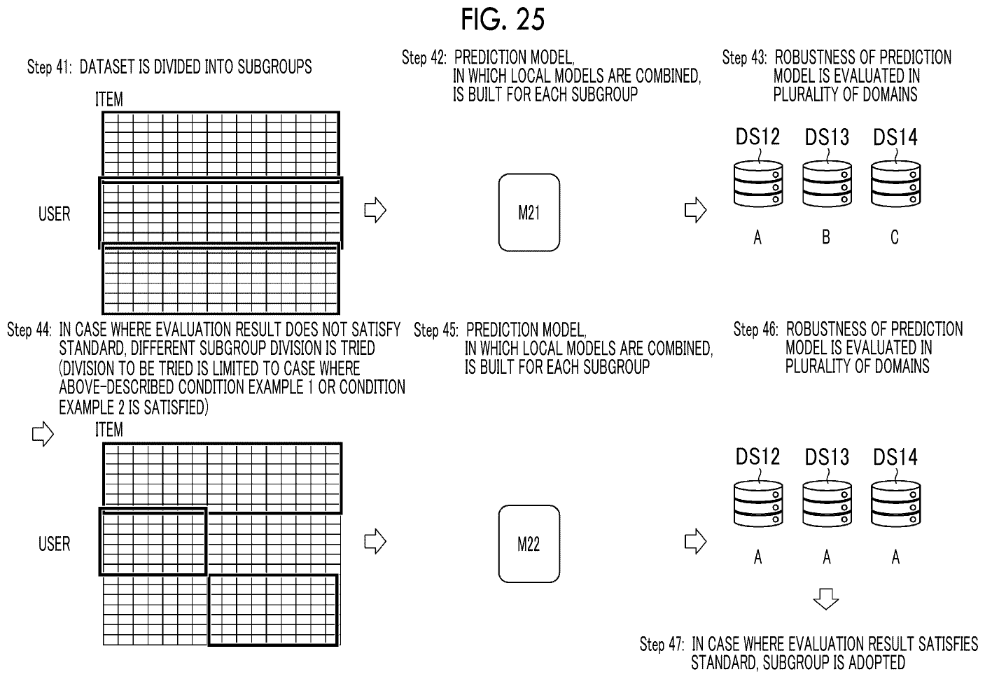

FIG. 25 is an explanatory diagram showing a subgroup division flow according to Embodiment 4.

In step 41, the dataset is divided into the subgroups. That is, the dataset acquisition unit 160 acquires the dataset, and the division unit 162 divides the dataset into the plurality of subgroups.

In step 42, a prediction model is built by combining the local models for each subgroup divided in step 41. That is, the learning unit 164 builds a local model for each subgroup by using the data of the plurality of subgroups. Further, the learning unit 164 builds a model M21 which is the prediction model in which the plurality of local models for each subgroup are combined.

In step 43, the robustness of the prediction model is evaluated in a plurality of domains. In the example shown in FIG. 25, the evaluation unit 166 evaluates the robustness of the model M21 built in step 42 by using data of the entire range of the datasets DS12, DS13, and DS14. Here, the robustness of the models LM21 obtained by using the datasets DS12, DS13, and DS14 are each Evaluation A, Evaluation B, and Evaluation C.

In step 44, in a case where the evaluation result satisfies the standard, the subgroup is adopted, and in a case where the evaluation result does not satisfy the standard, different subgroup division is tried. That is, the evaluation unit 166 compares the evaluation standard with the evaluation result in step 43. For the evaluation standard, for example, “all the robustness obtained by using each dataset is Evaluation A”. Here, the evaluation standard is not satisfied. Therefore, the division unit 162 divides the dataset into subgroups different from those in step 41. The division of the subgroup to be tried by the division unit 162 is limited to the case where the above-described condition example 1 or the condition example 2 is satisfied.

In step 45, a prediction model is built by combining the local models for each subgroup divided in step 44. That is, the learning unit 164 builds a local model for each subgroup by using the data of the plurality of subgroups and builds a model M22, which is a prediction model where a plurality of local models are combined.

In step 46, the robustness of the prediction model is evaluated in a plurality of domains. Similar to step 43, the evaluation unit 166 evaluates the robustness of the model M22 by using the datasets DS12, DS13, and DS14. Here, all the robustness of the model M22 obtained by using the datasets DS12, DS13, and DS14 is Evaluation A.

In step 47, in a case where the evaluation result satisfies the standard, the subgroup is adopted. That is, the evaluation unit 166 compares the evaluation standard with the evaluation result in step 46. Here, all the robustness of the model M22 is Evaluation A and satisfies the evaluation standard. Therefore, it can be said that the subgroup divided in step 44 is robust with respect to the domain shift. That is, in a case where the result of the evaluation of the robustness of the local model with respect to the domain shift satisfies the standard, the subgroup of the local model is robust with respect to the domain shift. Therefore, the evaluation unit 166 adopts the subgroup divided in step 44.

### Embodiment 5

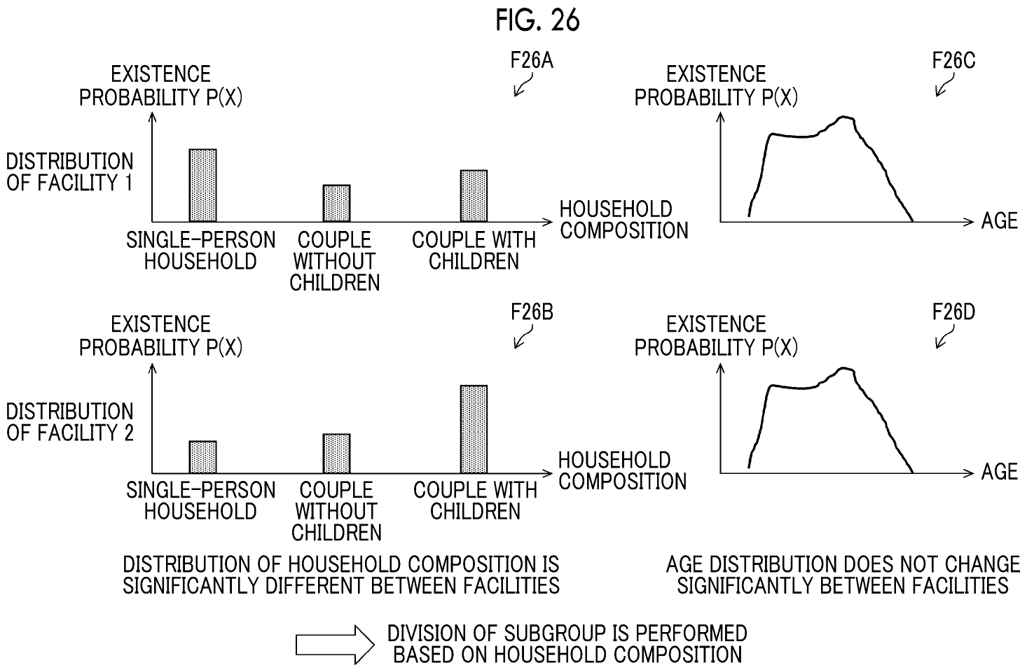

For the division of the subgroup, it is preferable to use the attribute data in which a difference in the probability distribution between the domain of the dataset to be divided and the domain of the dataset used for the evaluation is relatively large. FIG. 26 is a diagram illustrating an attribute for the subgroup division. Here, a case will be described in which a dataset of a “facility 1” is divided into subgroups to build a local model, and the built local model is evaluated by using a dataset of a “facility 2”.

F26A is a graph showing an existence probability P(X) for each household composition of the “facility 1”, and F26B is a graph showing an existence probability P(X) for each household composition of the “facility 2” different from the “facility 1”. As shown in F26A, at the “facility 1”, the “single-person household” has the highest existence probability, the “couple with children” has the next highest existence probability, and the “couple without children” has the lowest existence probability. On the other hand, as shown in F26B, at the “facility 2”, the “couple with children” has the highest existence probability, the “couple without children” has the next highest existence probability, and the “single-person household” has the lowest existence probability.

As described above, the distribution of the household composition is significantly different between the “facility 1” and the “facility 2”. That is, a difference in the probability distribution is relatively large in the attribute data of the household composition. Therefore, in order to build a local model that is robust with respect to the domain shift, it is preferable to perform the subgroup division based on the household composition.

F26C is a graph showing an existence probability P(X) of each age at the “facility 1”, and F26D is a graph showing an existence probability P(X) of each age at the “facility 2”. As shown in F26C and F26D, the age distribution does not change significantly between the “facility 1” and the “facility 2”. That is, a difference in the probability distribution of the attribute data of the age is relatively small. Therefore, it is not possible to build a local model that is robust with respect to the domain shift even by the subgroup division based on age.

In this way, by dividing the dataset into the plurality of subgroups by using the attribute data with relatively large differences in the probability distributions, the dataset can be divided into the plurality of subgroups that are robust with respect to the domain shift, and the local model that is robust with respect to the domain shift can be built.

### Embodiment 6

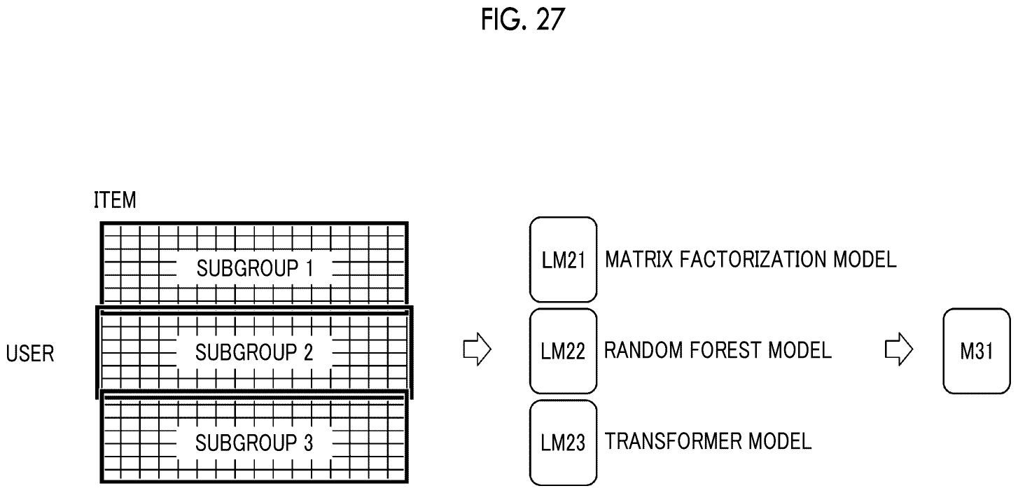

The plurality of local models, which are built for each subgroup, need not all be the same type of model and may be different types of models for each subgroup. FIG. 27 is a diagram illustrating a local model for each subgroup.

In the example shown in FIG. 27, the dataset is divided into three subgroups of a “subgroup 1”, a “subgroup 2”, and a “subgroup 3”. Further, a local model LM21 is built by using data of the “subgroup 1”, a local model LM22 is built by using data of the “subgroup 2”, and a local model LM23 is built by using data of the “subgroup 3”.

Here, the local model LM21 is a matrix factorization model. The local model LM22 is a random forest model. The local model LM23 is a transformer model. The local model to be built may be a model other than the matrix factorization model, the random forest model, and the transformer model. Here, although an example in which a plurality of local models are different types of models has been described, some of the plurality of local models may be models of the same type, and others may be models of a different type. In this way, in the local model building, an appropriate type of model can be selected for each subgroup.

### Embodiment 7

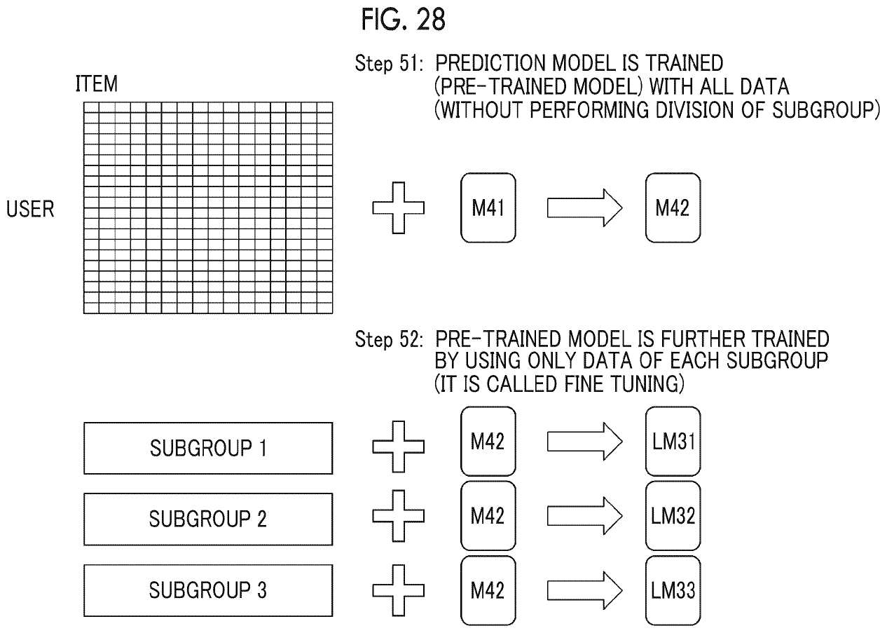

The plurality of local models may be models obtained by further training the local models of the subgroups using a pre-trained model trained in advance based on a wider range of data than the subgroups in each dataset as an initial parameter. FIG. 28 is an explanatory diagram showing a learning flow according to Embodiment 7.

In step 51, the prediction model is trained with all the data in the dataset. That is, the learning unit 164 trains a model M41 before training by using all the data of the dataset and builds a model M42 which is a pre-trained model.

In step 52, the model M42 is further trained by using only the data of each subgroup. That is, in the example shown in FIG. 28, the division unit 162 divides the dataset into three subgroups of the “subgroup 1”, the “subgroup 2”, and the “subgroup 3”. The learning unit 164 trains the model M42 by using the data of the “subgroup 1” to build a local model LM31. Similarly, the learning unit 164 trains the model M42 by using the data of the “subgroup 2” to build a local model LM32 and trains the model M42 by using the data of the “subgroup 3” to build a local model LM33. This learning is called fine tuning.

Here, although the model M42, which is a pre-trained model, is built by using all the data of the dataset, the model M42 may be built based on wider range of data than the subgroups divided from the dataset.

Regarding Program that Operates Computer

It is possible to record a program, which causes a computer to realize some or all of the processing functions of the information processing apparatus 100, in a computer-readable medium, which is an optical disk, a magnetic disk, or a non-temporary information storage medium that is a semiconductor memory or other tangible object, and provide the program through this information storage medium.

Further, instead of storing and providing the program in a non-transitory computer-readable medium such as a tangible object, it is also possible to provide a program signal as a download service by using an electric communication line such as the Internet.

Further, some or all of the processing functions in the information processing apparatus 100 may be realized by cloud computing or may be provided as a software as a service (SaaS).

Regarding Hardware Configuration of Each Processing Unit

The hardware structure of the processing unit that executes various processes such as the dataset acquisition unit 160, the division unit 162, the learning unit 164, the evaluation unit 166, and the combination unit 168 in the information processing apparatus 100 is, for example, various processors as described below.

Various processors include a CPU, which is a general-purpose processor that executes a program and functions as various processing units, GPU, a programmable logic device (PLD), which is a processor whose circuit configuration is able to be changed after manufacturing such as a field programmable gate array (FPGA), a dedicated electric circuit, which is a processor having a circuit configuration specially designed to execute specific processing such as an application specific integrated circuit (ASIC), and the like.

One processing unit may be composed of one of these various processors or may be composed of two or more processors of the same type or different types. For example, one processing unit may be configured with a plurality of FPGAs, a combination of CPU and FPGA, or a combination of CPU and GPU. Further, a plurality of processing units may be composed of one processor. As an example of configuring a plurality of processing units with one processor, first, as represented by a computer such as a client and a server, there is a form in which one processor is configured by a combination of one or more CPUs and software, and this processor functions as a plurality of processing units. Second, as represented by a system on chip (SoC) or the like, there is a form in which a processor, which implements the functions of the entire system including a plurality of processing units with one integrated circuit (IC) chip, is used. In this way, the various processing units are configured by using one or more of the above-mentioned various processors as a hardware-like structure.

Further, the hardware-like structure of these various processors is, more specifically, an electric circuit (circuitry) in which circuit elements such as semiconductor elements are combined.

### Advantages of Embodiment

According to the present embodiment, since local models of subgroups that are robust with respect to the domain shift are generated, by combining the plurality of local models, it is possible to prepare a high-performance model for an unknown introduction destination facility even in a case where the domain of the introduction destination facility is unknown at the step of training the model.

### Other Application Examples

In the above-described embodiment, although the user behavior related to purchase of products has been described as an example, the scope of application of the present disclosure is not limited to purchase of products, and the present disclosed technology can be applied to user behavior prediction related to various items such as browsing medical images, document browsing, contents watching such as videos, or the like, regardless of uses.

### Others

The present disclosure is not limited to the above-described embodiment, and various modifications can be made without departing from the spirit of the idea of the present disclosed technology.

### EXPLANATION OF REFERENCES

10: suggestion system
12: prediction model
14: model
100: information processing apparatus
102: processor
104: computer-readable medium
106: communication interface
108: input/output interface
110: bus
112: memory
114: storage
130: division program
132: learning program
134: evaluation program
136: combination program
140: dataset storage unit
142: learning model storage unit
152: input device
154: display device
160: dataset acquisition unit
162: division unit
164: learning unit
166: evaluation unit
168: combination unit
DS: dataset
DS1: dataset
DS2: dataset
DS3: dataset
DS11: dataset
DS12: dataset
DS13: dataset
DS14: dataset
Dtg: data
IT1: item
IT2: item
IT3: item
LM1: local model
LM2: local model
LM3: local model
LM11: local model
LM12: local model
LM12A: local model
LM21: local model
LM22: local model
LM23: local model
LM31: local model
LM32: local model
LM33: local model
M1: model
M2: model
M3: model
M11: model
M21: model
M22: model
M41: model
M42: model
SG1: subgroup
SG2: subgroup
SG3: subgroup
SG4: subgroup
SG5: subgroup
SG11: subgroup
SG12: subgroup
SG13: subgroup
SG21: subgroup
SG22: subgroup
SG23: subgroup
SG31: subgroup
SG32: subgroup
SG33: subgroup
SG34: subgroup
SG35: subgroup

What is claimed is:

1. An information processing method executed by one or more processors, comprising:
causing the one or more processors to execute:
dividing a dataset, which indicates a behavior of a user on an item for each of combinations of a plurality of the users and a plurality of the items, into a plurality of subgroups that are robust with respect to domain shift;
generating a local model for performing a prediction of the behavior of the user on the item for each of the subgroups; and
combining a plurality of the local models generated for each of the subgroups.

2. The information processing method according to claim 1,
wherein the dataset indicates the behavior of the user on the item for each of combinations of the plurality of users, the plurality of items, and a plurality of contexts.

3. The information processing method according to claim 2, further comprising:
causing the one or more processors to execute dividing the dataset based on at least one of attribute data of the user, attribute data of the item, or attribute data of the context.

4. The information processing method according to claim 1, further comprising:
causing the one or more processors to execute:
performing an evaluation of robustness of a model, in which the plurality of local models are combined, with respect to the domain shift; and
adopting division of the subgroup in a case where a result of the evaluation satisfies a standard.

5. The information processing method according to claim 4, further comprising:
causing the one or more processors to execute dividing the dataset into the plurality of subgroups by using attribute data having a relatively large difference in probability distribution between a domain of the dataset and a domain of the dataset that is used for the evaluation.

6. The information processing method according to claim 1, further comprising:
causing the one or more processors to execute dividing the dataset into the plurality of subgroups in which each user belongs to at least one or more of the subgroups.

7. The information processing method according to claim 1, further comprising:
causing the one or more processors to execute dividing the dataset into the plurality of subgroups in which at least a certain number or more of the items belong to each user.

8. The information processing method according to claim 1, further comprising:
causing the one or more processors to execute generating different types of local models for each of the subgroups.

9. The information processing method according to claim 1, further comprising:
causing the one or more processors to execute:
generating a pre-trained model based on a wider range of data than the subgroup in the dataset; and
generating the local model using the pre-trained model as an initial parameter.

10. The information processing method according to claim 1, further comprising:
causing the one or more processors to execute outputting an item list, which is suggested to the user, by using a model in which the plurality of local models are combined.

11. An information processing apparatus comprising:
one or more processors; and
one or more memories in which instructions to be executed by the one or more processors are stored,
wherein the one or more processors are configured to:
divide a dataset, which indicates a behavior of a user on an item for each of combinations of a plurality of the users and a plurality of the items, into a plurality of subgroups that are robust with respect to domain shift;
generate a local model for performing a prediction of the behavior of the user on the item for each of the subgroups; and
combine a plurality of the local models generated for each of the subgroups.

12. A non-transitory, computer-readable tangible recording medium which records thereon a program for causing, when read by a computer, the computer to realize:
a function of dividing a dataset, which indicates a behavior of a user on an item for each of combinations of a plurality of the users and a plurality of the items, into a plurality of subgroups that are robust with respect to domain shift;
a function of generating a local model for performing a prediction of the behavior of the user on the item for each of the subgroups; and
a function of combining a plurality of the local models generated for each of the subgroups.
